(19) United States
(12) Patent Application Publication
(10) Pub. No.: US 2017/0015531 A1
(43) Pub. Date: Jan. 19, 2017

(54) STRADDLE CARRIERS

(71) Applicant: RSF Enterprises (Aust) Pty Ltd, Fig Tree Pocket (AU)

(72) Inventor: Tommy Schults, Fig Tree Pocket (AU)

(73) Assignee: RSF Enterprises (Aust) Pty Ltd, Fig Tree Pocket (AU)

(21) Appl. No.: 15/122,325

(22) PCT Filed: Feb. 19, 2015
(86) PCT No.: PCT/AU2015/050062

§ 371 Date: Aug. 29, 2016

(30) Foreign Application Priority Data
Mar. 12, 2014 (AU) 2014900837

(51) Int. Cl. B66C 19/00

(52) U.S. Cl. CPC B66C 19/007

(57) ABSTRACT

A straddle carrier is operable to lift and convey a shipping container. The straddle carrier has a plurality of wheeled structures between weight-bearing portions and the ground. Each wheeled structure has two or more wheels. Each of the wheels is turnable (i.e. steerable) relative to the wheeled structure to which it is connected. Each wheeled structure is also pivotable (by at least by at least 90° in a horizontal plane) relative to the weight-bearing portion which it supports. Consequently, the wheeled structures can be oriented so as to enable the straddle carrier to move forward, to steer by turning (steering) one or more wheels, or to move perpendicular to the straddle carrier's forward direction.

### TECHNICAL FIELD

The present invention relates to straddle carriers.

### BACKGROUND

A straddle carrier is a kind of machine/vehicle used for lifting and conveying shipping containers over short distances (e.g. within a loading yard associated with a factory, or a storage facility, or at a cargo shipping port, or the like). For land transportation over larger distances, shipping containers are generally transported by truck or rail.

Shipping containers come in a range of sizes. Two common shipping container sizes are so-called “20 foot” containers which are approximately 20 ft (6.1 m) long, and so-called “40 foot” containers which are approximately 40 ft (12.2 m) long. Both of these container sizes are approximately 8 ft (2.44 m) wide and approximately 8½ ft-9½ ft (2.6 m-2.9 m) high.

Straddle carriers may be said to fall into two general categories; namely “large” straddle carriers on the one hand, and small or “mini” straddle carriers on the other. The distinction between these two categories is discussed below.

Large straddle carriers are used mainly at major cargo shipping ports and like facilities. Due to the nature of major shipping port facilities where huge volumes of cargo (i.e. huge numbers of containers) must be loaded, unloaded, moved, etc, on a time-critical basis, large straddle carriers used at such major port facilities are necessarily very large and heavy pieces of equipment, often capable of lifting two or more full (20 foot or 40 foot) shipping containers at once. Also, to enable cargo to be loaded/unloaded/moved as quickly as possible at major ports, large straddle carriers are often capable of moving (including whilst carrying one or more shipping containers) at relatively high-speeds, often up to 30 km/h (or even faster). Large straddle carriers are also typically designed to be able to lift or carry shipping containers high in the air. This can be important or necessary at major shipping ports where containers are often stacked high, one atop another, sometimes up to four high. This may be done for empty containers which are being stored, and/or for full containers which are waiting to be loaded onto ships, etc. Hence, large straddle carriers typically have frame/support/lifting structures which extend high above the ground into the air.

Large straddle carriers can be unsuitable for use in smaller non-shipping-port type applications/facilities such as, for example, at distribution centres or temporary storage yards where smaller numbers of containers are taken (and perhaps temporarily stored) before individual containers are loaded onto trucks for separate delivery/distribution to their ultimate destination. Distribution centres for supermarket or retail store chains, military storage or maintenance yards, factories, etc, are some examples of facilities that may fall into this category. Those skilled in the art will appreciate that numerous other examples of such or similar facilities may also exist.

There are several reasons why large straddle carriers are often unsuitable for use at/in these kinds of smaller facilities. For one thing, large straddle carriers are often too large, and in particular too high, to fit inside storage warehouses or other buildings or sheds inside which the shipping containers are often kept, or into which they are taken for loading/unloading, etc, at such facilities. Also, the weight of large straddle carriers is typically too great for (and would damage/destroy) the concrete or other sealed surface of the yard, roads, etc, on which the straddle carriers operate at such facilities (i.e. the open areas in which the straddle carriers move around at such facilities). The concrete or other sealed surfaces on which large straddle carriers operate at major cargo shipping ports are typically thickened or otherwise strengthened/reinforced to withstand the weight of large straddle carriers.

Hence, mini straddle carriers are typically employed for lifting and transporting shipping containers over relatively short distances at these smaller, non-port facilities. Compared to large straddle carriers, mini straddle carriers are generally much smaller and lower. For example, they normally have a frame/structure high enough to lift no more than one container at a time, and they are normally only high enough to stack containers up to two (or perhaps three) high (and to reach and lift the top container in such a stack). The height of mini straddle carriers is also generally such that they can fit inside, and through the doors of, warehouses, storage sheds, factories, etc. Mini straddle carriers are also generally much lighter than large straddle carriers and are therefore less damaging to the concrete or other sealed surface (yard, roads, etc) on which the mini straddle carriers operate.

A problem sometimes arises—and this problem applies to both large and mini straddle carriers—that the number of shipping containers that can be stored within a given area (e.g. within a yard at a depot, or outside a factory, or at a port, etc) is limited, at least partly, by the amount of space/room required by the straddle carrier itself to navigate in and around the shipping containers and/or between, beside, containers or other obstacles. This is discussed further by way of example with reference to FIG. 1.

FIG. 1 schematically illustrates a typical outdoor storage area with a building or structure B on one side. A similar storage area configuration could also exist indoors, for example inside a warehouse or the like. In FIG. 1, the building/structure B could be, for example, a factory, a warehouse, a covered storage facility, etc, or even a structure such as a container lifting crane (or multiple thereof) at a port facility. For convenience, the structure B in FIG. 1 will be referred to as a building. The adjacent storage area might therefore be thought of as a storage yard associated with the building.

Adjacent the building B, there is a road R. The road R happens to the on the left of the building B in FIG. 1, but other configurations are of course also possible. To the left of the road R (in the example of FIG. 1) is an area S used for storing shipping containers C. FIG. 1 is a plan view of the yard. Therefore, each of the shipping containers C shown in FIG. 1 could be an individual shipping container resting directly on the ground, or alternatively each C in FIG. 1 (or some of them) could be a stack of multiple shipping containers stacked vertically one atop another. For the purpose of simplicity, let it be assumed at this point that each C in FIG. 1 represents a single shipping container resting directly on the ground.

In FIG. 1, the road R and the storage area S actually comprise one large area. In other words, this is really a single large area with no physical delineation or separation between the road R and the storage area S, although for safety and efficiency in practice there may be painted lines, signs, etc, on the ground to indicate designated areas for placement of containers, vehicle lanes, pedestrian walkways, etc (similar to those used on airport tarmacs). In any event, the area which forms the road R adjacent the building B should generally remain clear and therefore is not used for storing shipping containers C. This is so that the road R remains unobstructed for use as a road, and also so that trucks and other vehicles can pull up alongside the building B temporarily, e.g. to load/unload, but the shipping containers C are not stored in a way/location that would obstruct access to and from the building B (vehicular access, pedestrian access, etc).

Additionally, a certain amount of space is required between the building B and the storage area S to allow room for a straddle carrier to make the turn, etc, as necessary when placing a shipping container in, or retrieving a shipping container from, the storage area S. By way of example, one shipping container is labelled as C′ in FIG. 1, and shipping container C′ is shown positioned generally in line with the other containers but oriented with its long axis perpendicular to the road R. The position and orientation of shipping container C′ in FIG. 1 is actually one which shipping containers could not be stored in (at least, in the example in FIG. 1, containers of the size shown could not be stored in this position and orientation given the room available) because, as indicated by arrow (i), if a container were to be in this position and orientation, it would not be possible for the straddle carrier to retrieve it as there is not enough room between the container C′ and the building B for the straddle carrier to pick up the container C′ and then make the turn onto the road R. (It therefore actually would not be possible, in this example, for the container C′ to even be placed in this position to start with, at least not using a straddle carrier with the turning circle shown.) This is therefore why all of the other shipping containers C in FIG. 1 are oriented at an angle diagonal to the direction of travel on the road R; namely so the containers C can be placed thus, and retrieved, using a straddle carrier with the turning circle shown (as indicated by arrows (ii) and (iii)). However, as those skilled in the art will appreciate, the need to place containers at an angle in this way means that the number of containers that can be accommodated in a given area (e.g. within area S in FIG. 1) is often less than the number that could be accommodated in the same area if the containers could be positioned squarely (or approximately squarely, rather than diagonally) and/or closer together, and this is especially the case for storage areas which (like the area S in FIG. 1) are generally square or rectangular in shape (or parts of them are).

Whilst this problem (namely the fact that the number of shipping containers that can be accommodated in a given area is often restricted or limited due to the space/room which the straddle carrier requires to operate) is explained above by way of example with reference to FIG. 1, those skilled in this field will readily appreciate how this problem may also manifest itself in a range of other scenarios and/or yard/storage area configurations.

It is thought that it might be desirable if this problem could be overcome or at least alleviated to some extent. However, it is to be clearly understood that mere reference herein to previous or existing apparatus, products, systems, methods, practices, publications or other information, or to any associated problems or issues, does not constitute an acknowledgement or admission that any of those things individually or in any combination were known, or formed part of the common general knowledge of those skilled in the field, or that they are admissible prior art.

### SUMMARY OF THE INVENTION

In one broad form, the invention relates to a straddle carrier which is operable to lift and convey a shipping container or any other kind or form of object or load. It is therefore to be understood that whilst the present invention (in this and other forms) will often be used for (embodied in) straddle carriers which are designed to or otherwise able to lift and convey a shipping container, the invention is not necessarily limited to this and it may be used for (embodied in) straddle carriers which are designed to or otherwise able to lift and convey objects/things other than shipping containers. Nevertheless, for convenience, the invention and its various features and embodiments will be described with reference to straddle carriers which are operable to lift and convey shipping containers.

The straddle carrier in this form of the invention may have a forward direction being a direction which is parallel to a longitudinal axis of the container (or other load) when the container (or other load) is supported by the straddle carrier. The straddle carrier may also have:
a plurality of weight-bearing portions which bear the weight of the shipping container (or other load) when the container (or other load) is supported above the ground by the straddle carrier; and
a plurality of wheeled structures between the weight-bearing portions and the ground, one wheeled structure supporting each weight-bearing portion above the ground, wherein
   each wheeled structure has two or more wheels, the wheels on each wheeled structure being connected to the wheeled structure at locations that are spaced apart from each other, at least, relative to a principal or lengthwise axis of the wheeled structure;
   each of the wheels is turnable (i.e. steerable) (often by at least 90°) relative to the wheeled structure to which it is connected; and
   each wheeled structure is pivotable (by at least by at least 90° in a horizontal plane) relative to the weight-bearing portion which it supports; whereby:
      the wheeled structures can be oriented with their principal or lengthwise axes parallel to the straddle carrier's forward direction and with their wheels oriented so as to enable the straddle carrier to move in the straddle carrier's forward direction, albeit also with the ability to steer by turning (steering) one or more wheels; and
      the wheeled structures can also be oriented with their principal or lengthwise axes perpendicular to the straddle carrier's forward direction and with the wheels oriented so as to enable the straddle carrier to move perpendicular to the straddle carrier's forward direction, albeit also with the ability to steer by turning (steering) one or more wheels.

Embodiments of the invention will therefore have a plurality of weight-bearing portions. These bear the weight of the shipping container when the container is supported above the ground by the straddle carrier, for example, when the shipping container is lifted and/or conveyed by the straddle carrier. Thus, the weight of the shipping container (and likely a good proportion of the straddle carrier's own self weight as well) will be supported on the ground, in a plurality of distinct regions, by multiple wheels on the ground (the multiple wheels of a given wheeled structure) in each region, and the weight-bearing portions are the parts or portions of the straddle carrier which perform the weight-bearing function and which connect or extend to the wheeled structure in each region.

It is envisaged that, typically, straddle carriers in accordance with embodiments of the invention will have four weight-bearing portions (and hence four wheeled structures—one wheeled structure for each weight-bearing portion). It is of course possible that some embodiments may have more than four weight-bearing portions, for example six or eight or more (and a corresponding number of wheeled structures). It is even possible that an odd number of weight-bearing portions (e.g. three) may be provided in some embodiments. However, it is thought that the use of three (or an odd number) of weight-bearing portions could sometimes restrict the versatility of the straddle carrier somewhat in terms of its ability to move/navigate relative to shipping containers and other obstacles. The reason for this will be discussed by way of example below. In any event, such potential versatility restrictions may be avoided or reduced if the straddle carrier has an even number of weight-bearing portions, and especially if it has four weight-bearing portions. This versatility may also be assisted, where there is an even number of weight-bearing portions, if the respective weight-bearing portions on either side of the straddle carrier are aligned with one another; that is, for example, if a line from one weight-bearing portion on one side of the straddle carrier to the adjacent weight-bearing portion on the other side of the straddle carrier is perpendicular to the straddle carrier's forward direction/axis.

It is to be clearly understood that the form and configuration of the weight-bearing portions is not critical to the invention. Indeed, the weight-bearing portions could take any suitable form. Some examples might include simple vertical (or near vertical) uprights or “legs” (e.g. resembling pillars or posts), or multiple structural members which together form one single weight-bearing portion (these could perhaps distribute the load between them in a similar manner to a truss or space frame structure), or curved structural members or structural members of other shapes, etc. It is envisaged that, in many embodiments, there will be four weight-bearing portions, and these four weight-bearing portions will take the form of, or they will at least include, substantially vertical uprights or “legs”. However, as has been said, no particular limitation is to be implied in this regard.

Embodiments of the invention will also include a plurality of wheeled structures between the weight-bearing portions and the ground. More specifically, there will be one wheeled structure supporting each weight-bearing portion above the ground. Each wheeled structure will have two or more wheels, and the wheels on each wheeled structure will be connected to that wheeled structure at locations that are spaced apart from each other, at least, relative to a principal or lengthwise axis of the wheeled structure. The fact that the wheels on each wheeled structure are “spaced apart” means that the wheels will not be positioned with one immediately beside or immediately behind another (this might otherwise cause the two or more wheels to operate, in effect, as a single wheel in terms of the way pressure caused by the weight of the straddle carrier and its load is applied to the ground by those wheels). This is therefore why the wheels on each of the straddle carrier's wheeled structures are “spaced apart” from each other. In some embodiments, on some or all of the wheeled structures, the size of the separation between the respective wheels may be, at least, the same as the wheels' radius. Often, the separation will be greater than this.

As mentioned above, on a given wheeled structure, the respective wheels are not only “spaced apart” from each other, but they are spaced apart (at least) relative to a principal axis of the wheeled structure. Typically, the principal axis of a wheeled structure will be an axis which extends centrally through the wheeled structure parallel to the wheeled structure's lengthwise direction/dimension. Often, on a given wheeled structure, the locations where the respective wheels (or intermediate/linking/mounting structural parts associated with the wheels) connect with the wheeled structure will be aligned with one another along, or parallel to, the wheeled structure's lengthwise axis. However, these connection locations (i.e. where the respective wheels, or their intermediate/linking/mounting structural parts, connect to the wheeled structure) are not necessarily limited to being aligned with one another along or parallel to the wheeled structure's lengthwise axis. Therefore, on a given wheeled structure, the connection location(s) associated with one or more wheels could be located on one side of the lengthwise axis, and the connection location(s) associated with one or more other wheels could be located the other side of the lengthwise axis. Having said this, the respective wheels on a given wheeled structure should still be separated from one another relative to the wheeled structure's lengthwise axis to ensure the wheels are adequately spaced apart to distribute the straddle carrier's weight on the ground.

The actual form and configuration of the straddle carrier's wheeled structures is not critical to the invention. Indeed, the wheeled structures could take any suitable form. Also, in some embodiments, the configuration of all of the wheeled structures may be the same or similar. Alternatively, in other embodiments, one or more of the straddle carrier's wheeled structures may have a different configuration compared with others.

It is envisaged that, in some embodiments (such as the embodiments discussed below with reference to the Figures), the straddle carrier will have four weight-bearing portions, each in the form of a vertical leg, and the wheeled structure associated with each leg will take the form of a bogie. In these embodiments, each bogie may have two wheels, and on each bogie the connection locations where the wheels (or the intermediate/linking/mounting structural parts associated with each wheel) attach to the bogie may be aligned with one another along the bogie's lengthwise axis.

As mentioned above, each of the straddle carrier's wheels is turnable (i.e. steerable) relative to the wheeled structure to which it is connected. For the avoidance of doubt, in this context, the fact that the wheels are “turnable” does not relate to the wheels' ability to roll. Of course, the wheels can roll, but in addition to this the wheels are “turnable” in the sense that they can be reoriented to point in different directions. In other words, they can be “steered” so that, if they are allowed to roll, they will roll in the direction in which they are steered. It is envisaged that, at least in some embodiments, the wheels (or some of them) may be able to turn/steer by at least 90° relative to the wheeled structure (bogie) to which they are attached.

The straddle carrier's wheels may be turnable/steerable, firstly, to enable the straddle carrier as a whole to steer as it moves (i.e. so that it is not limited to only moving in a straight line). However, in some embodiments, the ability of the wheels to turn relative to their respective wheeled structures may also help or contribute to the wheeled structures' (i.e. the bogies') ability to pivot relative to the respective weight-bearing portions (legs).

In this regard, it should be recalled that each wheeled structure (bogie) is pivotable relative to the weight-bearing portion (leg) which it supports. The reason why the respective wheeled structures (bogies) are pivotable relative to their respective weight-bearing portions (legs) is so that the wheeled structures can be:
(i) oriented with their lengthwise axes parallel to the straddle carrier's forward direction and with their wheels oriented so as to enable the straddle carrier to move in (or parallel to) the forward direction, albeit also with the ability to steer by turning (steering) one or more wheels; (in other words, so that the straddle carrier can move in the forward direction, or in reverse (parallel but opposite to the forward direction), and steer whilst doing so)
   but also so that the wheeled structures can be:
(ii) oriented with their lengthwise axes perpendicular to the straddle carrier's forward direction and with the wheels oriented so as to enable the straddle carrier to move perpendicular (i.e. sideways) to the straddle carrier's forward direction, albeit also with the ability to steer by steering one or more wheels; (in other words, so that the straddle carrier can move sideways and steer whilst doing so).

It will be appreciated that because the straddle carrier's wheeled structures (bogies) can be oriented with their lengthwise axes parallel to the forward direction, or perpendicular to the forward direction, the wheeled structures (bogies) will therefore generally be able to pivot by at least 90° in a horizontal plane relative to the weight-bearing portions (legs).

In some embodiments, the horizontal spacing between at least certain of the straddle carrier's weight-bearing portions may be varied. In some more specific embodiments, the horizontal spacing between at least certain of the straddle carrier's weight-bearing portions parallel to the straddle carrier's forward direction may be varied.

In embodiments where the straddle carrier has four weight-bearing portions, there may be two weight-bearing portions at the front relative to the straddle carrier's forward direction and two at the rear, and the horizontal spacing between the front weight-bearing portions and the rear weight-bearing portions may be varied. In such embodiments, the straddle carrier may have at least one front longitudinal member which is fixed in position relative to the front weight-bearing portions and which extends towards the rear weight-bearing portions, at least one rear longitudinal member which is fixed in position relative to the rear weight-bearing portions and which extends towards the front weight-bearing portions, and the horizontal spacing between the front weight-bearing portions and the rear weight-bearing portions may be varied by causing the horizontal position of the front longitudinal member(s) to be changed relative to the horizontal position of the rear longitudinal member(s) parallel to the straddle carrier's forward direction.

The straddle carrier in the above embodiments may also be provided with a guide structure located between the front and rear weight-bearing portions. Both the front longitudinal member(s) and the rear longitudinal member(s) may engage with, and may be supported by, the guide structure. When the horizontal spacing between the front weight-bearing portions and the rear weight-bearing portions is varied, one or both of the front longitudinal member(s) and the rear longitudinal member(s) may move horizontally relative to the guide structure parallel to the straddle carrier's forward direction.

The straddle carrier in various embodiments may be operable to lift a shipping container to varying heights. In some cases, the straddle carrier may be operable to lift a shipping container to a sufficient height, and to then position that container above at least one other container, such that the container can be placed on top of the at least one other container. Also, the straddle carrier may be able to move so as to be positioned substantially over a shipping container, or over multiple shipping containers stacked one atop another, and it may be able to then lift the topmost shipping container.

Straddle carriers in accordance with embodiments of the invention may also have one or more attachment points where the shipping container can attach to the straddle carrier, and the straddle carrier may be operable to adjust the height of the one or more attachment points relative to the ground. In some embodiments, the straddle carrier may have four weight-bearing portions and four attachment points, one attachment point being located near a vertically upper location on each of the respective weight-bearing portions, and the location of each attachment point relative to the vertically upper location on its associated weight-bearing portion may be fixed (i.e. unchangeable). Suitably, the height of the respective weight-bearing portions might be varied, and varying the height of the respective weight bearing portions may cause the height of the respective attachment points relative to the ground to vary. Each of the four weight-bearing portions might comprise a substantially vertical leg, each leg may include a plurality of parts which can move vertically relative to one another to vary the height of the leg, and on each leg the attachment point associated with that leg may be located near the top of the uppermost of the parts.

In some embodiments, the straddle carrier may further include a spreader assembly. The spreader assembly may have one or more attachment points to which the shipping container can attach, and the height of the one or more attachment points relative to the ground may be varied by varying the height of the spreader assembly above the ground.

In particular, a spreader assembly might be included in embodiments in which front and rear longitudinal members engage with, and are supported by, a guide structure. In these embodiments, the spreader assembly may be connected to the rest of the straddle carrier via an intermediate frame. The intermediate frame may be suspended from the guide structure in a height-adjustable manner, and the spreader assembly may be connected to the intermediate frame. A lifting mechanism may also be provided, and the height of the intermediate frame and the spreader assembly relative to the ground may be varied by operating the lifting mechanism. There is no limitation on the form or configuration which the lifting mechanism may take. However, in one example, the lifting mechanism may comprise one or more winches. The winches may be fixed in position relative to the guide structure, and the intermediate frame may be suspended by the winches such that the height of the intermediate frame (and hence height of the spreader assembly) relative to the ground can be varied by operating the winches.

The intermediate frame discussed above may be length adjustable, and it may have a forward portion which is maintained in fixed horizontal position relative to the front weight-bearing portions and a rearward portion which is maintained in fixed horizontal position relative to the rear weight-bearing portions. Consequently, when the horizontal spacing between the front weight-bearing portions and the rear weight-bearing portions is varied, the horizontal spacing between the forward and rearward portions of the intermediate frame may change accordingly. Preferably, the forward and rearward portions of the intermediate frame may be able to move vertically relative to the respective front and rear weight-bearing portions when the height of the intermediate frame is varied.

The spreader assembly discussed above may provide a plurality of attachment points, one or more toward the front and one or more towards the rear, and the spreader assembly may be length-adjustable such that the horizontal spacing between the front and rear attachment points can be varied. It may also be the case that the horizontal spacing between the front and rear attachment points on the spreader assembly, and the horizontal spacing between the front weight-bearing portions, can each be varied independently of one another.

Generally, at least one wheel of the straddle carrier should be a driven wheel. In some cases, at least one wheel on each wheeled structure may be a driven wheel.

It will be appreciated from above that each of the wheeled structures may be able to pivot relative to the associated weight-bearing portion so that each wheeled structure can be controllably oriented with its principal or lengthwise axis parallel to, or perpendicular to, the straddle carrier's forward direction. In order to pivot each wheeled structure, in cases where at least one wheel on each wheeled structure is driven wheel, the wheels on each wheeled structure may first be turned relative to the wheeled structure so as to become oriented substantially perpendicular to the wheeled structure's lengthwise axis, and the driven wheel(s) on each wheeled structure may then be “driven” in an appropriate direction such that the wheeled structures are thereby caused to pivot relative to their respective weight-bearing portions.

As an alternative, each of the wheeled structures may be provided with a mechanism for lifting and pivoting that wheeled structure relative to the associated weight-bearing portion, whereby each wheeled structure can be lifted off the ground, pivoted, and lowered back to the ground, and in this way each wheeled structure may be able to pivot relative to the associated weight-bearing portion so as to be selectably oriented with its principal or lengthwise axis parallel to, or perpendicular to, the straddle carriers forward direction.

In another broad form, the invention relates to a straddle carrier which is operable to lift and convey a shipping container, although again this form of the invention may also be used for (embodied in) straddle carriers which are designed to lift and convey any other kinds or forms of object or load. The straddle carrier in this form may have:
a plurality of weight-bearing portions which bear the weight of the shipping container (or other load) when the container (or other load) is supported above the ground by the straddle carrier, and
a horizontal spacing between at least certain of the straddle carrier's weight-bearing portions may be varied.

In some more specific embodiments, the straddle carrier may have a forward direction being a direction which is parallel to a longitudinal axis of the container (or other load) when the container (or other load) is supported by the straddle carrier, and the horizontal spacing between at least certain of the straddle carrier's weight-bearing portions may be varied parallel to the straddle carrier's forward direction.

Any of the features described herein (including with reference to any one form of the invention) can be combined in any combination with any one or more of the other features described herein (including with reference to any other form of the invention) within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. This specification, including the Detailed Description below, makes reference to a number of drawings as follows:

FIG. 1 is a schematic illustration of an example outdoor storage yard with a building on one side. The building could be, for example, a factory, warehouse, storage facility, etc, and the area adjacent the building provides a road and an area for storing shipping containers.

FIG. 2 is a perspective illustration of mini a straddle carrier, but the mini straddle carrier in FIG. 2 does not embody the present invention. It does, however, incorporate a number of components, systems and functionalities that may be shared by straddle carriers that do embody the invention. Hence, FIG. 2 is included, at least partly, to help illustrate and explain these components, systems and functionalities.

FIG. 3 is a perspective illustration of a large straddle carrier in accordance with one possible embodiment of the invention. In FIG. 3, the large straddle carrier is shown carrying a 20 foot shipping container and the straddle carrier is travelling in a “forward” direction (or at least in a direction parallel to the straddle carrier's “forward” axis).

FIG. 4 is a perspective illustration of the same large straddle carrier as in FIG. 3, but unlike FIG. 3, FIG. 4 shows the straddle carrier travelling in a “sideways” direction (i.e. in a direction perpendicular to the straddle carrier's forward axis). FIG. 4 again shows the large straddle carrier carrying a 20 foot shipping container, and to help provide context, it illustrates how the large straddle carrier might be used to place a shipping container on, or retrieve a shipping container from, a stack of other like shipping containers.

FIG. 5 is similar to FIG. 3 in that it shows the same large straddle carrier moving in a forward direction (or in a direction parallel to the straddle carrier's forward axis), however unlike FIG. 3, FIG. 5 illustrates the straddle carrier carrying a 40 foot shipping container.

FIG. 6 is similar to FIG. 4 in that it shows the large straddle carrier moving sideways, however unlike FIG. 4, FIG. 6 shows the straddle carrier carrying a 40 foot shipping container and it illustrates how the straddle carrier might be used to place this container on, or retrieve it from, a stack of other 40 foot shipping containers.

FIG. 7 is a perspective view of the upper portion of the large straddle carrier in FIG. 3 to FIG. 6. In FIG. 7, some parts of the straddle carrier's structure are shown transparently to more clearly illustrate, in particular, the way the straddle carrier's intermediate frame can slide vertically up and down on rails associated with the straddle carrier's respective vertical supports/legs.

FIG. 8 illustrates certain of the upper parts of the large straddle carrier in FIG. 3 to FIG. 7, with all other parts of the straddle carrier omitted. FIG. 8 helps to illustrate, in particular, how the straddle carrier's intermediate frame and spreader can be raised and lowered by the crane winches.

FIG. 9 is a view (from below and to the side) of the upper portion of the large straddle carrier in FIG. 3 to FIG. 8. In FIG. 9, the straddle carrier is partially extended (cf the extended configuration in FIG. 10 which is required in some circumstances, for example, when the straddle carrier is moving sideways and lifting a 40 foot container from a stack as in FIG. 6). FIG. 9 helps to illustrate the straddle carrier's spreader, and the attachment points on the spreader which attach to the corners of the shipping container.

FIG. 10 is similar to FIG. 9 in that it is a view (from below and to the side) of the upper portion of the large straddle carrier, except that unlike FIG. 9 which shows the straddle carrier partially extended, FIG. 10 shows the straddle carrier extended.

FIG. 11 is a perspective illustration of a large straddle carrier in accordance with an embodiment of the invention which is slightly different from the embodiment in FIG. 3 to FIG. 10. Similar to FIG. 3, FIG. 11 shows the large straddle carrier in this embodiment carrying a 20 foot shipping container and the straddle carrier is travelling in a “forward” direction (or at least in a direction parallel to the straddle carrier's “forward” axis).

FIG. 12 is a perspective illustration of the same large straddle carrier as in FIG. 11, but unlike FIG. 11, FIG. 12 shows the straddle carrier travelling in a “sideways” direction (i.e. in a direction perpendicular to the straddle carrier's forward axis). FIG. 12 also shows this large straddle carrier carrying a 40 foot shipping container, and to help provide context, it illustrates how the large straddle carrier might be used to place a shipping container on, or retrieve a shipping container from, a stack of other like shipping containers.

FIG. 13 illustrates certain of the lower parts (lower portions of the legs, and the bogies) of the large straddle carrier in FIG. 11 and FIG. 12. FIG. 13 helps to illustrate how, in this embodiment, the straddle carrier's bogies can be lifted by, and pivoted on, a jack. FIG. 13 also helps to illustrate the particular mechanism used in this embodiment for securing adjacent bogies to one another, in different configurations.

FIG. 14 is a perspective illustration of a mini straddle carrier in accordance with another possible embodiment of the invention. In FIG. 14, the mini straddle carrier is illustrated carrying a 20 foot shipping container and is travelling in a “forward” direction (or at least in a direction parallel to the straddle carrier's “forward” axis).

FIG. 15 is a perspective illustration of the same mini straddle carrier as in FIG. 14, but unlike FIG. 14, FIG. 15 shows the straddle carrier travelling in a “sideways” direction (i.e. a direction perpendicular to the straddle carrier's forward axis). FIG. 15 again shows the mini straddle carrier carrying a 20 foot shipping container, and to help provide context, it illustrates how the mini straddle carrier might be used to place a shipping container on, or retrieve a shipping container from, a stack of other like shipping containers.

FIG. 16 is similar to FIG. 14 in that it shows the same mini straddle carrier carrying a 20 foot container, however unlike FIG. 14 which shows the straddle carrier moving forward (or parallel to the forward axis), FIG. 16 illustrates the way that the bogies on the ends of each of the straddle carrier's supports/legs can pivot relative to the rest of the straddle carrier to enable the straddle carrier to move in a range of different ways; e.g. not just forward or sideways, but also diagonally (relative to the forward axis), or so as to turn/rotate “on the spot”, or so that the straddle carrier moves in an arc with one end of the straddle carrier moving while the other end remains substantially stationary, etc.

FIG. 17 is similar to FIG. 14 in that it shows the same mini straddle carrier moving in a forward direction (or parallel to the straddle carrier's forward axis), however unlike FIG. 14, FIG. 17 illustrates the straddle carrier carrying a 40 foot shipping container.

FIG. 18 shows the mini straddle carrier carrying a 40 foot shipping container and moving sideways (i.e. perpendicular to the straddle carrier's forward axis), and it illustrates how the straddle carrier might be used to place this container on, or retrieve it from, a stack of other 40 foot shipping containers.

FIG. 19 is similar to FIG. 16 in that it illustrates the way that the bogies on the end of each of the straddle carrier's supports/legs can pivot relative to the rest of the straddle carrier to enable the straddle carrier to move in a range of different ways. However, unlike FIG. 16 where the straddle carrier is shown carrying a 20 foot shipping container, FIG. 19 illustrate the straddle carrier carrying a 40 foot shipping container.

FIG. 20 illustrates the mini straddle carrier carrying a 40 foot shipping container and moving forward (or parallel to the forward axis). However, unlike FIG. 14 to FIG. 19 above which all illustrate this mini straddle carrier in a “raised” configuration (i.e. with the straddle carrier's legs extended to their full/maximum height), in contrast FIG. 20 illustrates the mini straddle carrier in a “lowered” configuration where the supports/legs of the straddle carrier have been telescopically lowered. This not only lowers the height at which the shipping container is supported/carried relative to the ground, it also reduces the overall height of the straddle carrier which may in turn enable the straddle carrier to, for example, pass beneath bridges or overhead power lines, pass through warehouse doors, etc. This “lowered” configuration may also be a more desirable configuration for the straddle carrier to adopt when conveying/transporting a single shipping container because, in this lowered configuration, the overall centre of gravity of the straddle carrier +the container is reduced, and consequently the straddle carrier may be more stable, less likely to topple or sway, etc.

FIG. 21 is a view of the mini straddle carrier in the extended and raised configuration. FIG. 21 shows, inter alia, the attachment points for a shipping container.

FIG. 22 illustrates an individual leg, and the associated pivotable bogie, of the mini straddle carrier in FIG. 14 to FIG. 21.

FIG. 23 is like FIG. 1 in that it schematically illustrates an identical yard to the one in FIG. 1, with a building on one side and an area adjacent the building which forms a road and an area for storing shipping containers. However, whereas the shipping containers in FIG. 1 are (mostly) positioned at a diagonal relative to the road/building (to enable the shipping containers to be positioned and retrieved by a straddle carrier with a certain minimum turning radius), in contrast in FIG. 23 the shipping containers are positioned “squarely” relative to the road and the boundaries of the storage area. As a result, in FIG. 23 a larger number of shipping containers are stored in the same area (compared with FIG. 1). This kind of preferable storage pattern/arrangement can be achieved using a straddle carrier in accordance with the present invention.

FIG. 24 is a perspective illustration of a mini straddle carrier in accordance with yet another possible embodiment of the invention. In FIG. 24, the mini straddle carrier is illustrated lowered, carrying a 20 foot shipping container, and is travelling in a “forward” direction (or at least in a direction parallel to the straddle carrier's “forward” axis).

FIG. 25 is a front-on view of the mini straddle carrier in FIG. 24.

FIG. 26 is a side-on view of the mini straddle carrier in FIG. 24.

FIG. 27 is a schematic illustration intended to help explain certain considerations that may affect the design of straddle carriers in accordance with the present invention.

### DETAILED DESCRIPTION

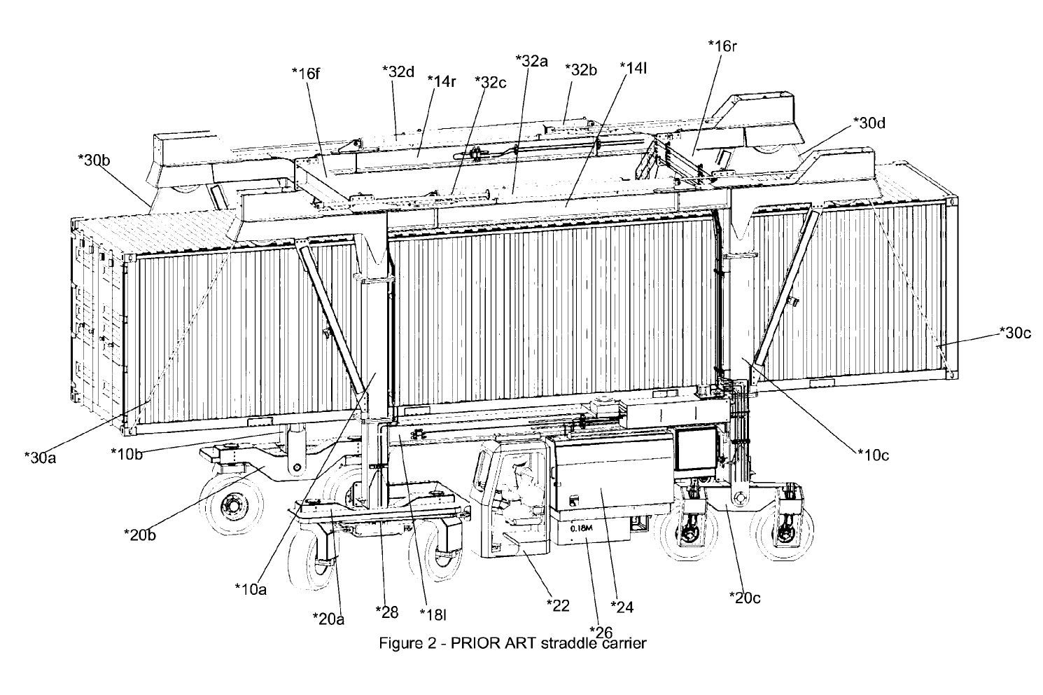

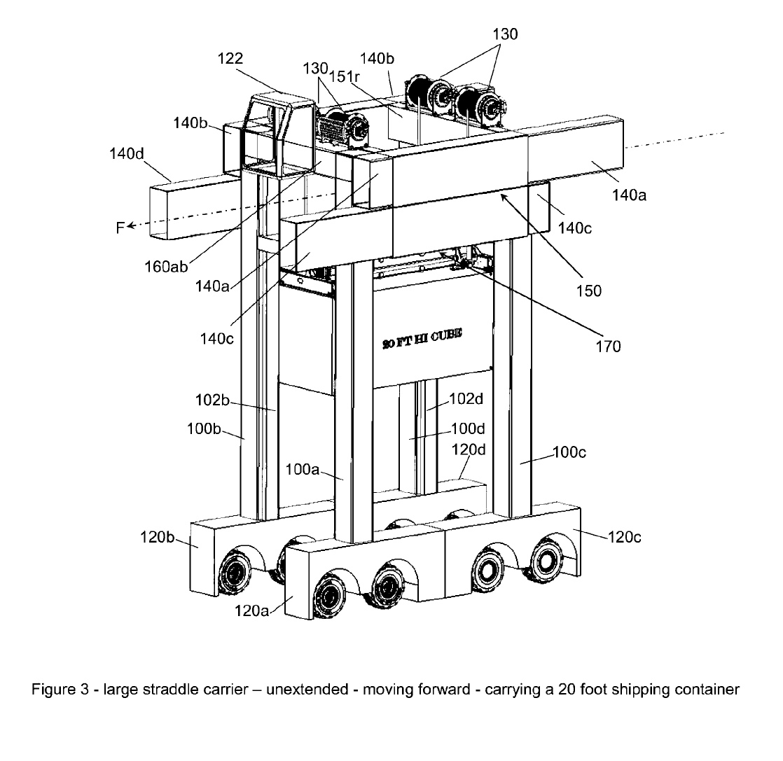

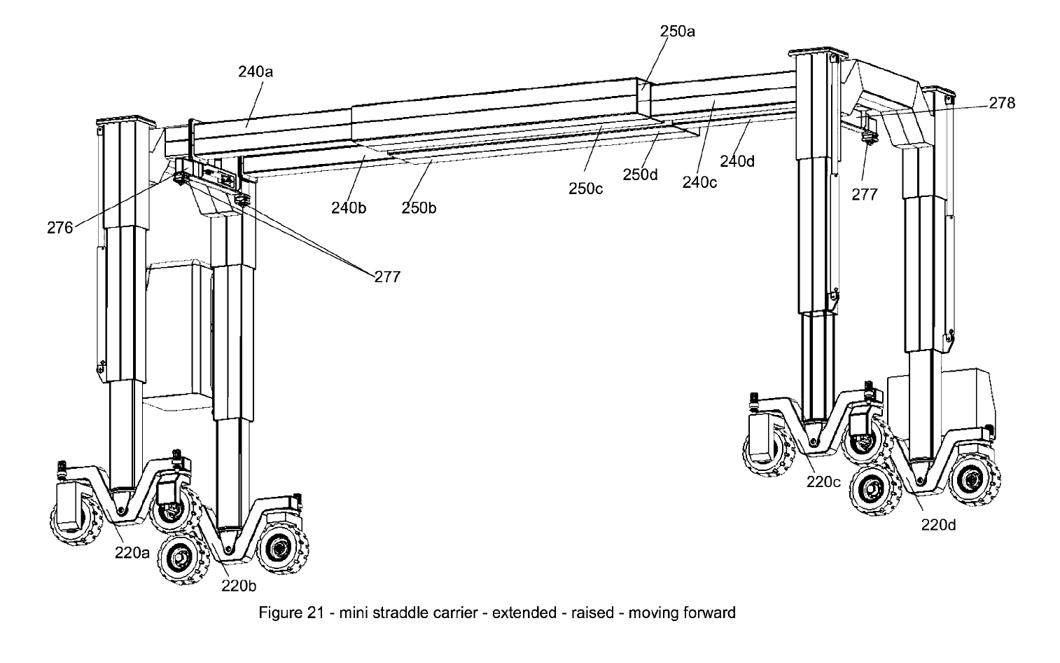

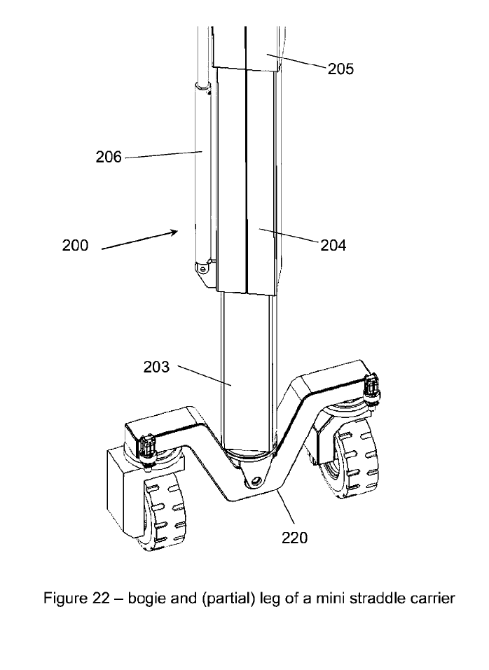

Several of the Figures, including FIG. 3 to FIG. 22, illustrate straddle carriers in accordance with various possible embodiments of the invention. However, before discussing the embodiments of the invention illustrated in FIG. 3 to FIG. 22, it is useful to first discuss the straddle carrier shown in FIG. 2.

FIG. 2—mini straddle carrier that does not embody the present invention

The straddle carrier in FIG. 2 is a mini straddle carrier. For the avoidance of any doubt, the mini straddle carrier in FIG. 2 does not embody the present invention. It does, however, incorporate a number of components, systems and functionalities that may be shared by straddle carriers which do embody the invention, and fence FIG. 2 is shown partly to help illustrate and explain these. Also, to avoid confusion between the mini straddle carrier in FIG. 2 which does not embody the invention, and the straddle carriers depicted in other Figures which do embody the invention, all reference numbers identifying features in FIG. 2 will be prefixed with an asterisk (*).

It can be seen that the frame of the mini straddle carrier in FIG. 2 includes four main uprights *10a-*10d. Uprights *10a and *10b are the straddle carriers front left and front right uprights, respectively, and uprights *10c and *10d are the rear left and rear right uprights, respectively (upright *10d is not actually visible in FIG. 2). The respective uprights are supported above the ground by the wheels, etc, as discussed below.

The uprights *10a-*10d of the mini straddle carrier in FIG. 2 are connected to one another by other frame members. These other frame members include the elongate top bearers *14l and *14r, the transverse connecting members *16f and *16r and the longitudinal connecting members *18l and *18r (longitudinal connecting member *18r is hidden from view in FIG. 2 but it essentially mirrors longitudinal connecting member *18l). There is also a bogie connected to the base of each of the uprights. The bogie connected to the base of upright *10a is labelled as bogie *20a, the bogie connected to the base of upright *10b is labelled as bogie *20b, etc.

The mini straddle carrier in FIG. 2 has a driver's cabin *22. The controls for operating the straddle carrier are located inside the cabin *22, such that a driver can sit inside the cabin *22 to drive the straddle carrier and operate the straddle carrier's other functions (e.g. the lifting mechanism—see below). The driver's cabin *22 is mounted to or otherwise supported (directly or indirectly) by the longitudinal connecting member *18l. The driver's cabin *22 is therefore located partially beneath the longitudinal connecting member *18l. Also mounted to or supported (directly or indirectly) by the longitudinal connecting member *18l is the straddle carrier's engine. The engine itself is not shown in FIG. 2, but the engine cover *24 is clearly visible immediately behind the driver's cab and *22. The engine and associated equipment are housed inside the engine cover *24. A fuel tank *26 is also supported underneath the engine cover *24.

Pump(s) (engine driven), valves, etc, which operate the hydraulic systems of the straddle carrier in FIG. 2 (based on driver controls) are located near the engine, many just behind and/or above the engine cover *24. Hydraulic lines (not individually labelled in FIG. 2) which convey fluid to different parts of the straddle carrier can also be seen. For example, there are hydraulic lines extending from the engine area:
directly to the rear wheels attached to bogie *20c,
up upright *10c, along the forward-facing side of connecting member *16r and down upright *10d to the rear wheels attached to bogie *20d,
along the outside of the longitudinal connecting members *18l and *18r and down the front uprights *10a and *10b towards the front wheels,
etc.

Parts of the straddle carrier in FIG. 2 which are operated by the fluid delivered by these hydraulic lines include:
hydraulic motors located inside the straddle carrier's four rear wheels, namely the wheels attached to bogie *20c and bogie *20d (the hydraulic motors in these rear wheels drive rotation of the said wheels in order to impart motion to the straddle carrier),
the steering mechanism (discussed below),
the lifting mechanism (discussed below),
etc.

As just mentioned, the straddle carrier in FIG. 2 has a hydraulically driven steering mechanism. More specifically, in the straddle carrier in FIG. 2, the four front wheels can turn to steer the straddle carrier. That is to say, the two wheels attached to front bogie *20a, and the two wheels attached to front bogie *20b, can turn in order to steer that straddle carrier. Note that in FIG. 2, only the two wheels attached to front bogie *20a are shown in a “turned” orientation. The other two front wheels (two wheels attached to front bogie *20b) appear to be facing straight ahead. This would not occur in practice. In practice, all four of the front wheels of the straddle carrier in FIG. 2 would turn at the same time in order to steer the straddle carrier smoothly. Whilst all four front wheels turn at the same time in a given direction, the amount that each one turns in said direction relative to the amount that the others turn in said direction is controlled by a steering linkage. This is so that the four respective wheels each turn the correct amount (and the amount that each individual wheel turns may be different to the others). The reason why each of the four wheels will often turn by a different amount is because the four wheels are located at different positions and must therefore trace out curved paths of different instantaneous radii as the straddle carrier is steered.

A part of the steering linkage *28 which connects the two wheels of bogie *20a, and which helps to ensure those two wheels turn the correct amount relative to one another, is visible in FIG. 2. A similar steering linkage is present on bogie *20b, although this is hidden from view. The straddle carrier in FIG. 2 can be steered using controls housed in the driver's cabin *22. In other words, controls in the driver's cab *22 can be used to operate steering linkages to turn the front wheels, and naturally if this is done (i.e. if the front wheels are turned) while the rear wheels are being driven to impart motion to the straddle carrier, the straddle carrier will “corner” (i.e. it will traverse a curved path according to the instantaneous orientation of the front wheels).

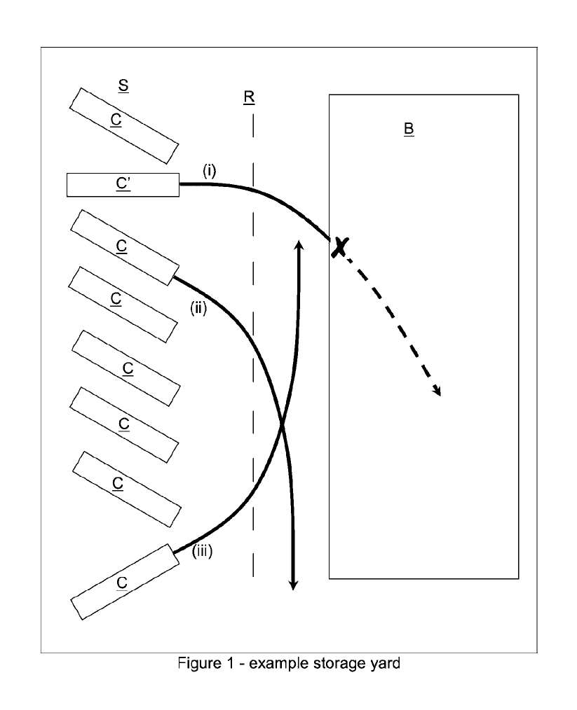

It should also be appreciated that (as is generally the case for all vehicle steering linkages/systems), in the straddle carrier in FIG. 2, the steering linkage is only operable to turn the straddle carrier's front wheels within a certain angle range. (For example, like the wheels of a conventional car, the front wheels of the straddle carrier in FIG. 2 cannot turn even close to 90° relative to their forward orientation.) Hence, in the straddle carrier in FIG. 2 (and similar straddle carrier designs), there is a limit to the extent by which the front wheels can turn, and this limit on the extent by which the front wheels can turn defines the minimum turning radius (i.e. the minimum turning circle) of the straddle carrier. One of the consequences of straddle carrier having a minimum turning radius is that this means the straddle carrier consequently requires a certain minimum amount of space/room to make turns, etc, and this can in turn restrict the number of shipping containers that can be stored within a given storage area, as discussed with reference to FIG. 1 above.

The straddle carrier in FIG. 2 is also able to lift a shipping container. Due to its height, the straddle carrier in FIG. 2 is only able to lift a single shipping container at a time. The straddle carrier in FIG. 2 is able to lift a shipping container off the ground so that the shipping container can be transported, and it can lower the shipping container back to the ground afterwards. To this end, the straddle carrier in FIG. 2 has four flexible members which, in this case, take the form of metal chains or cables. There is one cable/chain for attachment to each of the four base corners of the shipping container, as shown in FIG. 2. The chains/cables are labelled *30a, *30b, *30c and *30d in FIG. 2. There is also a hydraulic lifting cylinder *32a, *32b, *32c and *32d associated with each of the respective chains/cables. The hydraulic cylinders are generally elongate in shape. Cylinders *32a and *32c extend along the top of the left hand top bearer *14l while cylinders *32b and *32d extend along the top of the right hand top bearer *14r. Cylinders *32a and *32b are oriented such that their respective chains/cables (*30a and *30b) extend along and over the front ends of the top bearers (so that these two cable/chains can extend down to attach to the forward two base corners of a shipping container), whereas cylinders *32c and *32d are oriented such that their respective chains/cables (*30c and *30d) extend along and over the rear ends of the top bearers (so that these two cables/chains can extend down to attach to the rearward two base corners of a shipping container). A pulley is provided on either end of both of top bearers *14l and *14r. The pulleys operate as a guide for the respective cables/chains, and help to prevent damage to the cable/chains and the top bearers as the cable/chains move.

Each of the hydraulic lifting cylinders contains a piston, with the piston being linked to the cable/chain associated with that particular cylinder. Pressurizing a cylinder causes the piston inside the cylinder to move in a direction that causes the associated chain/cable to retract away from the ground (i.e. upwards). It will therefore be appreciated that, if all four chains/cables are first attached to respective base corners of the shipping container and the hydraulic cylinders are then pressurised simultaneously, the four chains/cables will be withdrawn away from the ground thus causing the shipping container to be lifted off the ground and into the air (i.e. to become suspended as shown in FIG. 2). Controls may be provided to ensure that (or at least help enable) all of the pistons (to) move (and therefore all of the cables to retract) at the same speed, or adjustably at different relative speeds, such that the shipping container is lifted in a controlled, level manner (i.e. so that the shipping container does not tip or roll whilst being lifted). The shipping container can be lowered to the ground by reversing the lifting process.

It should be noted that the wheels of the straddle carrier in FIG. 2, and even wheels which are connected to the same bogie, are separated from each other by an appreciable distance. This distance (i.e. the separation between wheels) is at least equal to the radius of the wheels, and generally more. The reason for the separation (i.e. distance) between individual wheels is to distribute the straddle carrier load over a greater number of separated (i.e. spaced apart) contact points, such that each individual contact point bears less of the overall load, thus reducing the propensity for damage to the concrete surface on which the straddle carrier operates.

In FIG. 2, the respective bogies are able to rock or “seesaw” somewhat relative to the respective uprights to which they each attach. That is, bogie *20a can seesaw somewhat at the base of upright *10a, bogie *20b can seesaw somewhat at the base of upright *10b, etc. FIG. 2 actually illustrates a situation where the front wheels are resting on or moving over level/horizontal ground, however the rear wheels attached to bogie *20c are resting on or moving over slightly uneven ground which slopes slightly upwards in the straddle carrier's direction of forward movement. In this situation, because of the ability of the bogie *20c to seesaw relative to upright *10c, despite the slightly angled inclination of the ground beneath the rear wheels of bogie *20c, nevertheless both wheels attached to bogie *20c remain in contact with the ground and therefore both wheels continue to support the straddle carrier.

FIG. 3 to FIG. 10—large straddle carrier in accordance with one possible embodiment

Turning now to FIG. 3 to FIG. 10, as mentioned above, these Figures illustrate one possible embodiment of the invention. In this embodiment, the straddle carrier is a large straddle carrier.

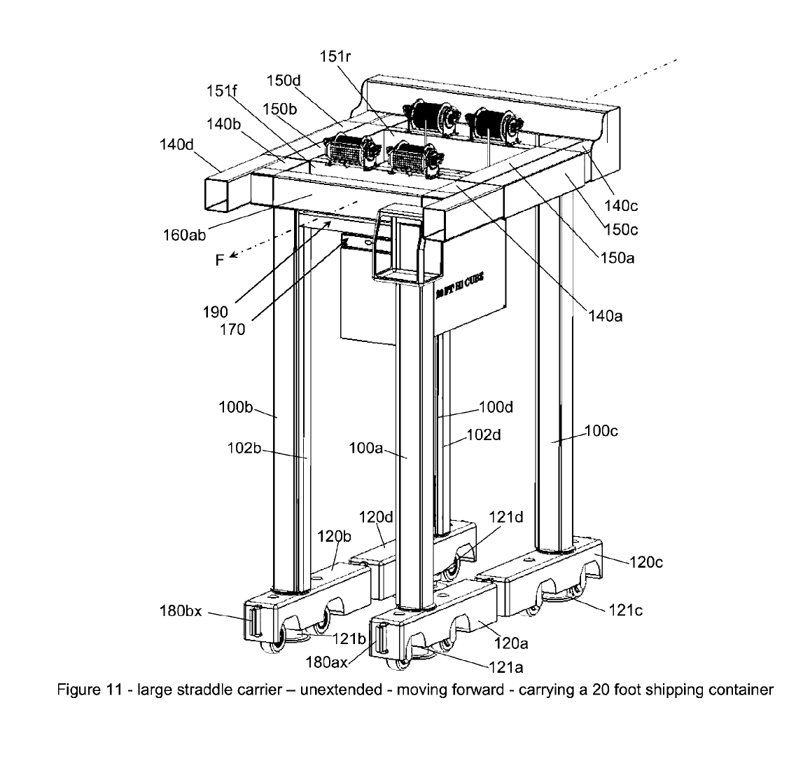

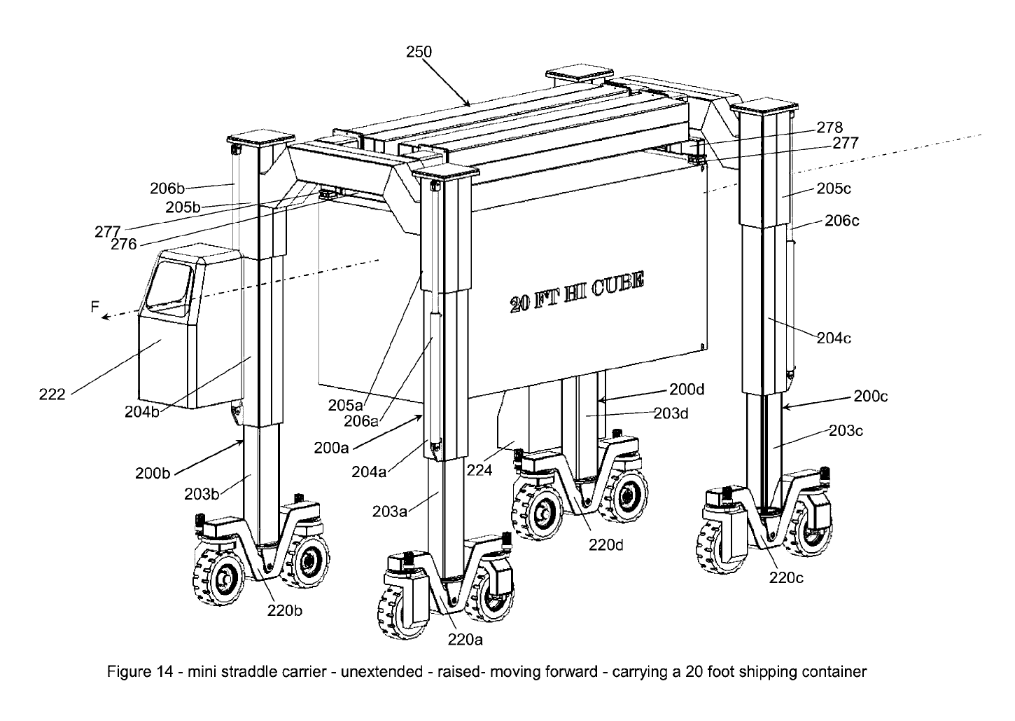

Importantly, a number of components and systems that would normally be required by or part of a straddle carrier (e.g. an engine, hydraulic systems, hydraulic lines, etc, to name a few) are omitted in FIG. 3 to FIG. 10 (and also in FIG. 11 to FIG. 13). However, the purpose and operation of these components and systems will be familiar to those skilled in this area, and in any case a number of these are described above (at least by way of example) with reference to FIG. 2. Hence, there is no need for these components and systems to be illustrated or described any further. Having said this, any of these components and systems (including but not limited to those described above with reference to FIG. 2) may of course be used or incorporated in straddle carriers like the one in FIG. 3 to FIG. 10, or in FIG. 11 to FIG. 13, or in FIG. 14 to FIG. 22, or which otherwise embody the invention.

Also, the configuration of the large straddle carrier in FIG. 3 to FIG. 10 (and likewise in FIG. 11 to FIG. 13), for example the frame design and structural configuration, the wheel/bogie design, the dimensions and overall layout, etc, is intended as an illustrative schematic representation only. That is, FIG. 3 to FIG. 10 (and likewise FIG. 11 to FIG. 13) are intended merely to help illustrate certain important features and functionalities which the invention may provide, and certain potential benefits it may have, when embodied in the form of a large straddle carrier. However, it is to be clearly understood that, in practice, the actual configuration/structure/construction of a large straddle carrier embodying the invention could be quite different to that shown in FIG. 3 to FIG. 10 (or in FIG. 11 to FIG. 13). Even if so, any (large or mini) straddle carrier with a differing configuration/structure but with one or more features and/or functionalities that are shared with or common/equivalent to the present invention will still fall within the scope of the present invention.

The overall layout of the large straddle carrier in FIG. 3 to FIG. 10 is similar, at least in general terms, to the layout of the mini straddle carrier illustrated in FIG. 2. For instance, like the mini straddle carrier in FIG. 2, the large straddle carrier in FIG. 3 to FIG. 10 includes four main upright support members (hereafter “legs”) 100a-100d.

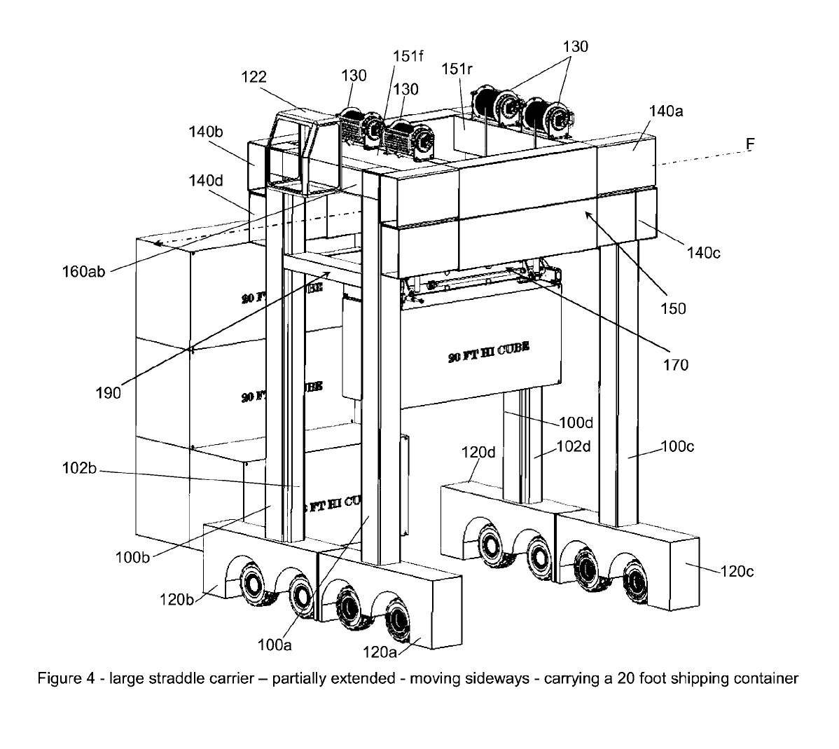

For consistency with FIG. 2, legs 100a and 100b in FIG. 3 to FIG. 10 will be referred to as the large straddle carrier's front left and front right legs, respectively, and legs 100c and 100d will be referred to as the large straddle carrier's rear left and rear right legs, respectively. However, for the straddle carrier in FIG. 3 to FIG. 10, the concept of what is the “front” of the straddle carrier is slightly different (or slightly less clearly defined) than for the straddle carrier in FIG. 2. For instance, FIG. 3 illustrates the large straddle carrier moving “forward”. Therefore, in the situation in FIG. 3, the “front” of the straddle carrier would be the side of the straddle carrier on which the driver's cabin 122 is situated. However, FIG. 4 illustrates the large straddle carrier moving sideways, and in that case, assuming the straddle carrier is moving in the direction towards the stacked shipping containers illustrated, the “front” of the straddle carrier might be said to be the side of the straddle carrier facing towards the stacked containers.

To avoid confusion in this regard (i.e. regarding what is the “front” of the straddle carrier, and what constitutes the straddle carrier's “forward” direction, in different situations) an axis F is illustrated in several of the Figures. Axis F may be considered to be the straddle carrier's “forward” axis, and the arrowhead on axis F may be said to define the straddle carrier's “forward” direction. Therefore, in FIG. 3, if the straddle carrier is moving in the direction indicated by the arrowhead on axis F, then the straddle carrier is said to be moving forward. Alternatively, if the straddle carrier is moving in a direction parallel to axis F but opposite to the direction indicated by the arrowhead, straddle carrier might be said to be moving backwards or in reverse. In the situation in FIG. 4, regardless of whether the straddle carrier is moving towards, or away from, the stack of shipping containers, the straddle carrier may be said to be moving sideways because it is moving perpendicular to axis F (i.e. sideways relative to the forward axis).

In the embodiment in FIG. 3 to FIG. 10, the legs 100a-100d are similar to the uprights of the straddle carrier in FIG. 2 insofar as they function as weight-bearing portions (for bearing the vertical components of the load, plus the vertical load created by the straddle carrier's self-weight, etc). The respective legs 100a-100d are also supported above the ground by wheeled bogies, as discussed below. However, in the large straddle carrier of FIG. 3 to FIG. 10, the front legs 100a and 100b are slightly longer than the rear legs 100c and 100d. The difference in height between the front legs 100a/b and the rear legs 100c/d is approximately equal to the vertical dimension of one of the longitudinal beams (see below), and the reason for this will be discussed below.

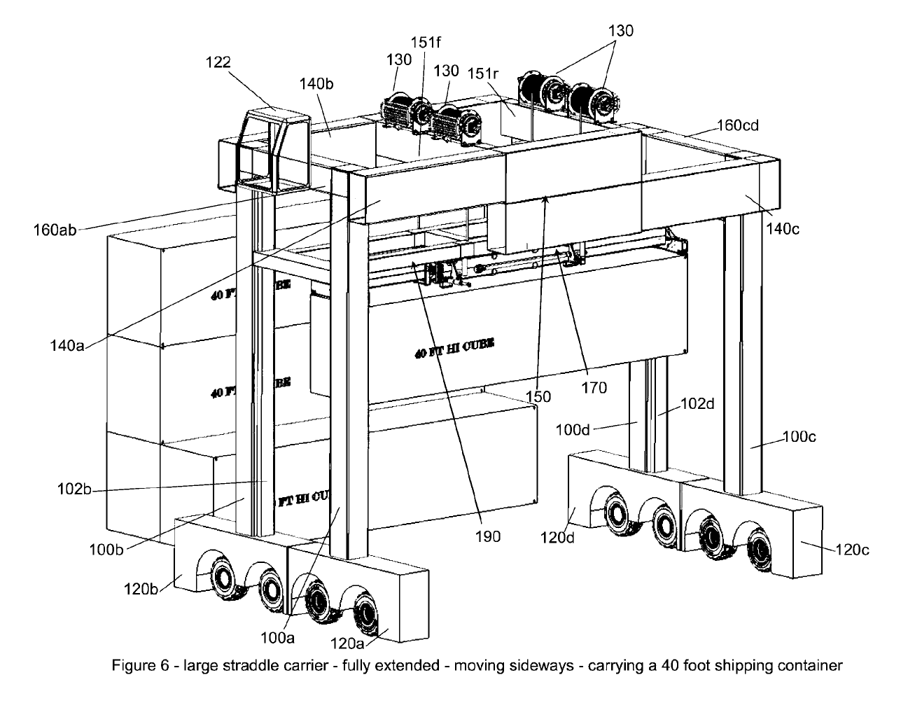

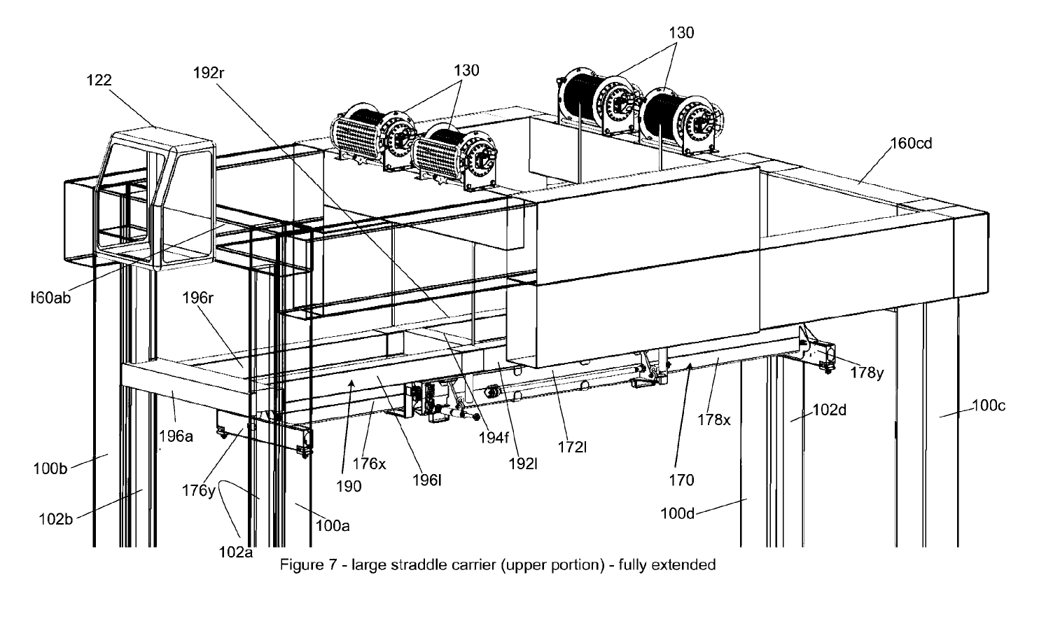

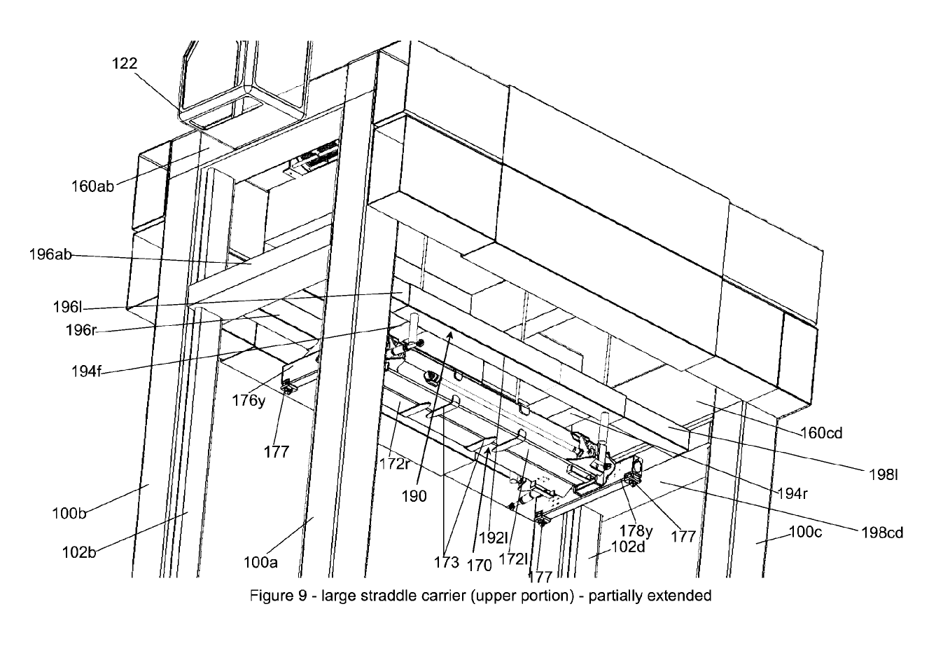

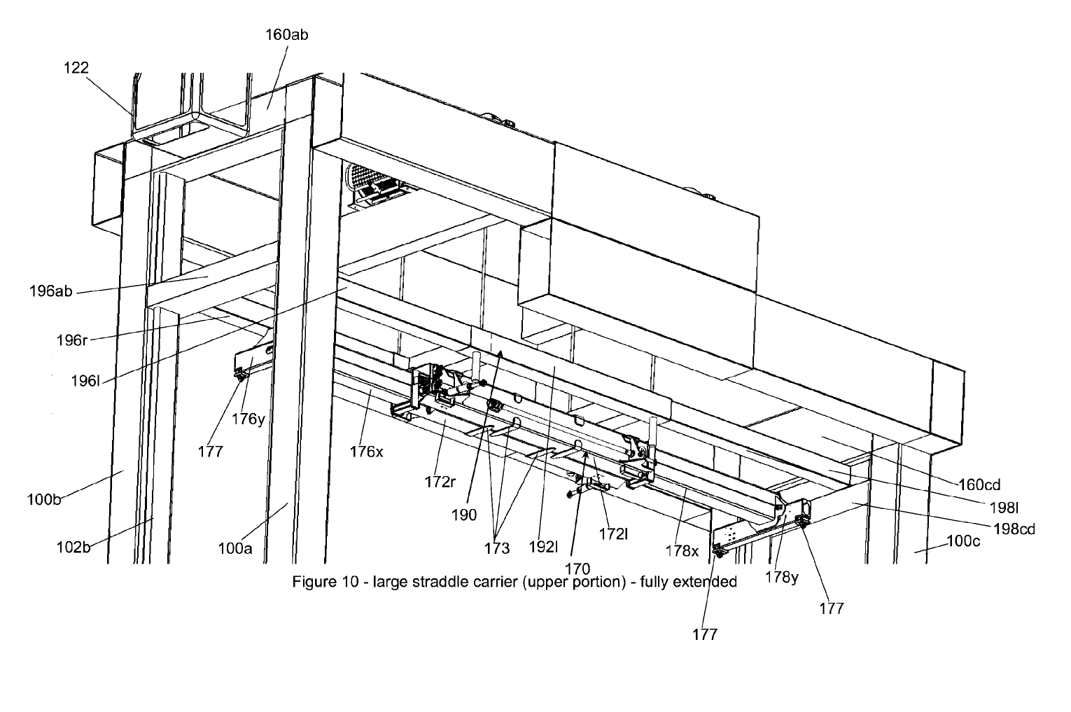

The legs 100a-100d of the straddle carrier in FIG. 3 to FIG. 10 are connected to other structural members. Legs 100a and 100b are fixedly connected to each other by a transverse member 160ab, and similarly legs 100c and 100d are fixedly connected to each other by a transverse member 160cd. (Transverse member 160cd is visible in FIG. 6, FIG. 7, FIG. 9 and FIG. 10.) The transverse member 160ab extends between the tops of the respective front legs 100a and 100b, and likewise the transverse member 160cd extends between the tops of the respective rear legs 100c and 100d.

In the large straddle carrier in FIG. 3 to FIG. 10, there are also structural frame members which extend longitudinally (i.e. horizontally and parallel to axis F). However, the configuration of these is quite different to the configuration of the longitudinal frame members in the mini straddle carrier in FIG. 2. In the mini straddle carrier in FIG. 2, the longitudinal frame members (incl. top bearers *14l and *14r, and longitudinal connecting members *18l and*18r) are rigid and maintain a set, non-variable distance of separation between the front uprights *10a/b and the rear uprights *10c/d in the longitudinal direction. In contrast to this, in the large straddle carrier in FIG. 3 to FIG. 10, the separation between the front legs 100a/b and the rear legs 100c/d is able to change. This can be appreciated by comparing, for example, FIG. 3 which shows the large straddle carrier in its unextended configuration with FIG. 6 which shows the large straddle carrier in its fully extended configuration. FIG. 4 and FIG. 9 also show the straddle carrier in a partially extended configuration which is in between these two extremes.

The longitudinally extending structural members of the straddle carrier in FIG. 3 to FIG. 10 include four longitudinal beams, namely longitudinal beams 140a, 140b, 140c and 140d. All four of these longitudinal beams are large and hollow with a rectangular cross-section. In other words, each comprises a large structural “box section” beam. The box-shaped cross section of each of the longitudinal beams 140a-d is longer in the vertical dimension than in the horizontal dimension, thus giving the beams particular rigidity, and resistance to bending, in the vertical plane.

The forward end of longitudinal beam 140a attaches at the top of leg 100a, on the outside of leg 100a, and longitudinal beam 140a extends from there toward the rear of the straddle carrier. Similarly, the forward end of longitudinal beam 140b attaches at the top of leg 100b, on the outside of leg 100b, and longitudinal beam 140b also extends from there toward the rear of the straddle carrier. At the rear, the rearward end of longitudinal beam 140c attaches at the top of leg 100c, on the outside of leg 100c, and longitudinal beam 140c extends from there forward toward the front of the straddle carrier. And similarly, the rearward end of longitudinal beam 140d attaches at the top of leg 100d, on the outside of leg 100d, and longitudinal beam 140d extends from there forward toward the front of the straddle carrier.

As mentioned above, the straddle carrier's rear legs 100c and 100d are shorter than the front legs 100a and 100b by an amount approximately equal to the vertical dimension of the longitudinal beams 140a/b. Consequently, the tops of the rear legs 100c and 100d are lower than the tops of the front legs 100a and 100b by the vertical height of the longitudinal beams 140a and 140b. As a result of this, the longitudinal beams 140c and 140d (which connect at the top of the respective rear legs 100c and 100d) extend horizontally parallel to, but just beneath, the longitudinal beams 140a and 140b (which connect at the top of the respective front legs 100a and 100b).

The large straddle carrier also has a large central guide structure 150. The guide structure 150 is located between the front and rear legs of the straddle carrier and it receives and supports the longitudinal beams 140a-d. More specifically, on either side of the guide structure 150 there is a pair of hollow rectangular through-channels. One of the through-channels on each side is disposed immediately above the other. These through-channels are size and shaped such that each one receives one of the respective longitudinal beams 140a-d, and the longitudinal beams are each able slide within their respective through-channel when the distance between the front and rear legs of the straddle carrier is changed.

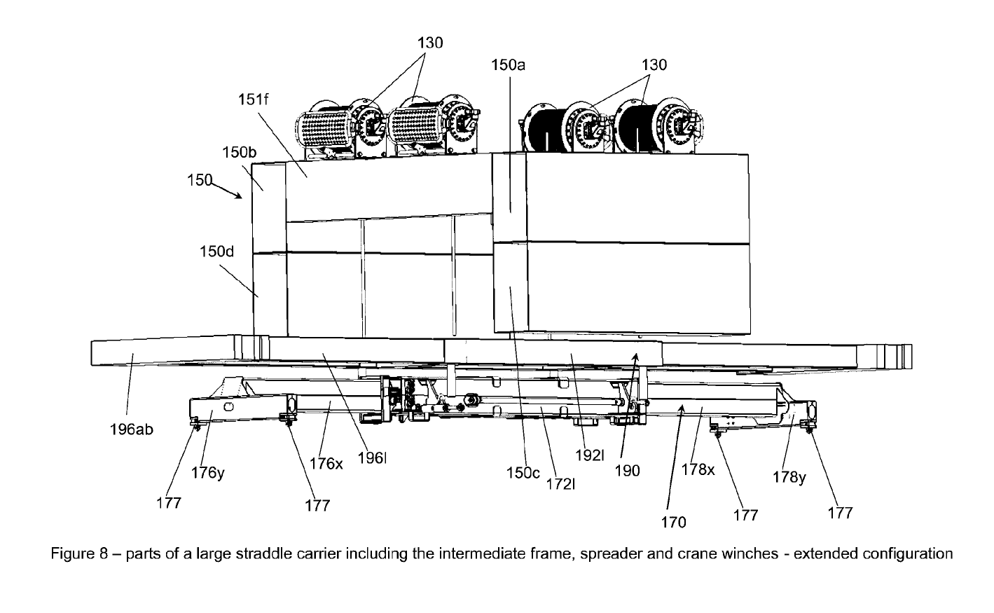

FIG. 8 illustrates the guide structure 150 but many of the other parts of the straddle carrier's structure, including the legs and the longitudinal beams, are hidden. The guide structure's individual through-channels are labelled 150a to 150d in FIG. 8. It will be appreciated that the longitudinal beam 140a is slideably received within through-channel 150a, the longitudinal beam 140b is slideably received within through-channel 150b, etc.

The guide structure 150 also includes a pair of transverse connecting members 151f and 151r. The transverse connecting members 151f and 151r rigidly connect the two sides of the guide structure 150 together. More specifically, the front transverse connecting member 151f extends between the upper, inner front corners of the through-channels 150a and 150b, and the rear transverse connecting member 151r extends between the upper, inner rear corners of the through-channels 150a and 150b.

The configuration of the guide structure 150 therefore enables the longitudinal beams associated with the front legs, and the longitudinal beams associated with the rear legs, respectively, to slide relative to the guide structure 150 (and relative to one another) when the distance between the front and rear legs is changed. However, aside from allowing this relative sliding movement of the longitudinal beams, the guide structure 150 otherwise forms a structural connection which holds the longitudinal beams together, keeps them suspended above (and generally parallel to) the ground, and it consequently helps to hold the straddle carrier's overall frame structure together.

FIG. 3 to FIG. 8 illustrate that the large straddle carrier includes a number of crane winches (hereafter “winches”) 130. In this particular embodiment, there are a total of four winches 130. Two of them (the forward two winches 130) are mounted directly on the transverse member 151f of the guide structure 150. The other two (the rearward two winches 130) are mounted directly on the transverse member 151r. The winches 130 themselves are conventional and need not be discussed in any detail. (Those skilled in this area will be familiar with winches and their operation.)

Ultimately, the winches 130 provide the lifting force used by the straddle carrier to lift shipping containers. However, the way in which the winches 130 are used in lifting containers, and the other components involved in this, will now be discussed.

Importantly, the metal cables associated with each of the winches 130 (i.e. the metal cables which wind on/off each respective winch) do not attach directly to a shipping container. (If the winch cables were to attach directly to a shipping container in order to lift the container, the suspended container could potentially swing drastically, and could quite easily collide with the straddle carrier's legs, etc.) Therefore, instead, the part of the straddle carrier to which a shipping container directly attaches when the shipping container is to be lifted is the spreader mechanism/assembly 170 (hereafter the “spreader” 170). The spreader 170 is visible (or at least parts of it are) in all of FIG. 3 to FIG. 10. However the spreader 170 itself, its operation, and the way it is mounted relative to other parts of the straddle carrier, can perhaps be most easily understood from FIG. 7 to FIG. 10.

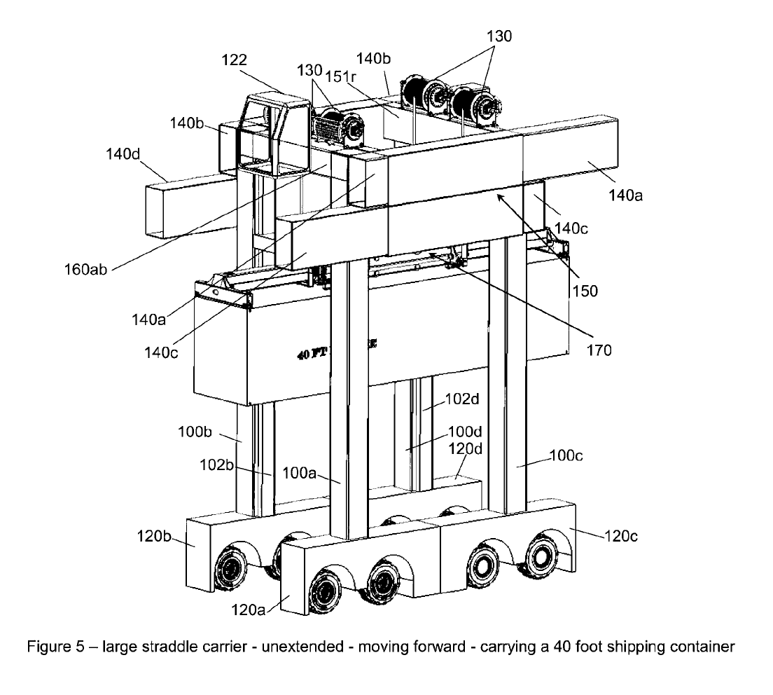

At this point it should be noted that the spreader 170 in this embodiment is an “extendable 20′-40′ spreader”. As the name suggests, an extendable 20′-40′ spreader can adopt a shortened configuration suitable for lifting 20 foot shipping containers (as illustrated in FIG. 3 and FIG. 4 for example) and also an extended configuration suitable for lifting 40 foot shipping containers (as illustrated in FIG. 5 and FIG. 6 for example). Spreaders, including extendable spreaders of this kind, have been used quite extensively with other kinds of straddle carriers in the past, and they will be familiar to those skilled in the art. Therefore the operation of the spreader will be discussed only insofar as is relevant to the present invention.

It should also be noted at this point, however, that in conventional straddle carriers, the spacing between the legs/uprights of the straddle carrier in the longitudinal direction (i.e. parallel to the straddle carrier's forward direction) is generally fixed and unchangeable. (The mini straddle carrier depicted in FIG. 2 is an example of this, although the mini straddle carrier in FIG. 2 does not use a spreader.) Thus, with conventional non-extendable straddle carriers that employ an extendable spreader, it is common for the spreader to be mounted directly to the legs of the straddle carrier or otherwise to structural members of the straddle carrier's frame which cannot move relative to one another. However, as mentioned above and also discussed further below, in the large straddle carrier in FIG. 3 to FIG. 10 (and likewise in FIG. 11 to FIG. 13), the spacing between the front legs and the rear legs can change. Furthermore, in the large straddle carrier of FIG. 3 to FIG. 10 (and likewise FIG. 11 to FIG. 13), the spacing between the front and rear legs of the straddle carrier will often need to be different to the length of the shipping container being lifted/transported at the time. As an example of this, FIG. 3 and FIG. 4 both show the large straddle carrier carrying a 20 foot shipping container. However, in FIG. 3 the straddle carrier is in the “unextended” configuration in which the legs are close together, whereas in FIG. 4 the legs are necessarily spaced wider apart (i.e. the straddle carrier is in a partially extended configuration) this being necessary to enable the straddle carrier's legs to pass on either side of the stack of shipping containers so that the shipping container being carried can be placed onto the stack (or perhaps the shipping container being carried in FIG. 4 has just been lifted off the stack). In any case, the point is, because the spacing between the front and rear legs of the straddle carrier in FIG. 3 to FIG. 10 (and likewise in FIG. 11 to FIG. 13) can change, the central part of the spreader 170 (which is of fixed length) cannot be fixedly mounted to the legs or to any other parts of the straddle carrier's structure which move relative to one another when the spacing between the legs changes.

For this reason, the spreader 170 is connected to the rest of the straddle carrier via an intermediate frame 190. Like the spreader 170, the intermediate frame 190 is visible (or at least parts of it are) in all of FIG. 3 to FIG. 10. However the intermediate frame 190 itself, and the way in which it is mounted and operates with other parts of the straddle carrier, can perhaps be most easily understood from FIG. 7 to FIG. 10.

From FIG. 7, it will be appreciated that the cables associated with the respective winches 130 attach directly to the central structure of the intermediate frame 190. Hence, the intermediate frame 190 is, in effect, suspended (i.e. held up by) the winch cables, and when the winches 130 are operated (typically all at the same time, and all with the same speed and direction) to wind the cables in, or wind the cables out, this causes the intermediate frame 190 to be lifted upwards towards, or lowered downwards away from, the guide structure 150 on which the winches 130 are mounted. Hence, in short, the winches 130 can be used to raise and lower the intermediate frame 190. The spreader 170 is connected to (suspended from) the intermediate frame 190, and a shipping container can connect directly to the spreader 170. Therefore, operating the winches 130 to raise and lower the intermediate frame 190 can ultimately cause a shipping container connected to the spreader 170 to be lifted and lowered.

As just mentioned, the winch cables attach directly to the central structure of the intermediate frame 190. The central structure of the intermediate frame is made up of two parallel, longitudinally extending through-channel members 192l and 192r, and these through-channel members are connected by a pair of transverse connecting members, namely transverse connecting member 194f (at the front) and transverse connecting member 194r (at the rear). The central structure of the intermediate frame is therefore generally rectangular, with the through-channel members 192l and 192r forming the sides, and the transverse connecting members 194f and 194r towards the front and rear respectively.

The intermediate frame 190 also includes a pair of extendable portions. One of these extendable portions is extendable from, and retractable into, the forward side of the intermediate frame's central structure. This one will be referred to as the forward extendable portion 196. The other extendable portion is extendable from, and retractable into, the rearward side of the intermediate frame's central structure. That one will be referred to as the intermediate frame's rearward extendable portion 198.

The intermediate frame's forward extendable portion 196 is itself made up of a pair of longitudinal members 196l and 196r, and a cross member 196ab. The longitudinal members 196l and 196r are parallel, spaced apart and shaped so as to be slidingly received within the forward open ends of the through-channels 192l and 192r respectively. Each of the longitudinal members 196l and 196r connects to the long rearward side of the cross member 196ab. Hence, the respective points at which the longitudinal members 196l and 196r connect to the cross member 196ab each form a T-junction.

From FIG. 3 to FIG. 10, it can be seen that the cross member 196ab of the forward extendable portion 196 extends horizontally in between the straddle carrier's front legs 100a and 100b. Likewise the cross member 198cd of the rear extendable portion 198 extends horizontally in between the straddle carrier's rear legs 100c and 100d. However, it is important to recognise that neither of the extendable portions' cross members (i.e. neither the cross member 196ab of the forward extendable portion nor the cross member 198cd of the rearward extendable portion) are fixedly connected to the straddle carrier's legs. On the contrary, they are able to move up and down relative to the straddle carrier's legs as the intermediate frame 190 is raised and lowered by the winches 130.

More specifically, it can be seen in FIG. 3 to FIG. 7, FIG. 9 and FIG. 10 that there is a wide, vertical rail extending down the inside of each of the straddle carrier's legs. Note that, in these Figures, only the rails associated with the straddle carrier's right-hand side legs 100b and 100d are clearly visible, because of the orientation in which the straddle carrier is shown. Regardless, the rail associated with the straddle carrier's front left leg 100a will be referred to as rail 102a, the rail associated with the straddle carrier's front right leg 100b will be referred to as rail 102b, etc.

On each end of the cross member 196ab, there is a pair of protrusions on either side of a recess/cut-out. This formation comprising protrusions on either side of a cut-out (one such formation on each end of the cross member 196ab) might be said to resemble a “C” shaped claw or a pair of jaws. In any case, the shape of the cut-out corresponds to the shape of the rails which extend down the inside of the legs. Hence, these jaw formations (one on each end of the cross member 196ab) are shaped so as to, in effect, extend around and “clasp” the vertical rail associated with the respective front legs of the straddle carrier. This is quite well shown in FIG. 7, where the front legs 100a and 100b and rails 102a and 102b are shown transparently so that the jaws on both ends of cross member 196ab can be seen clasping the respective rails. Importantly, whilst the jaw-like formations on either end of cross member 196ab clasp the respective leg rails, this clasping arrangement also permits relatives sliding movement between the cross member 196ab and the respective rails. Therefore, when the straddle carrier's winches 130 are operated to raise or lower the intermediate frame 190, the jaw formations on either end of cross member 196ab are able to freely slide up and down on the rails to permit the intermediate frame 190 to be raised and lowered.

Those skilled in the art will appreciate that whilst the jaw-like formations on the ends of the cross member 196ab, together with identical formations on either end of cross member 198cd, allow the intermediate frame 190 to slide up and down the rails as discussed above, nevertheless this engagement between the cross members 196ab and 198cd and the respective rails also helps to ensure that the intermediate frame 190 is otherwise held in position (i.e. restricted from any other movement) relative to the straddle carrier's legs. Thus, the intermediate frame 190 is prevented from disconnecting, twisting, swinging, etc, relative to the straddle carrier's legs.

Explanations have been given above of the forward extendable portion 196 of the straddle carrier's intermediate frame 190, and of the way the forward extendable portion 196 engages with the central structure of the intermediate frame and with the straddle carrier's front leg rails.

As those skilled in the art will appreciate, the intermediate frame's rearward extendable portion 198 is essentially a mirror image of the forward extendable portable 196. Therefore, the intermediate frame's rearward extendable portion 198 is made up of a pair of longitudinal members 198l and 198r, and a cross member 198cd. The longitudinal members 198l and 198r are parallel, spaced apart and shaped so as to be slidingly received within the rearward open ends of the through-channels 192l and 192r, respectively, of the intermediate frame's central structure. Each of the longitudinal members 198l and 198r connects to the long forward side of the cross member 198cd. Hence, the respective points at which the longitudinal members 198l and 198r connect to the cross member 198cd each form a T-junction.

Similar to the forward extendable portion 196, the cross member 198cd of the rearward extendable portion 198 extends horizontally in between the straddle carrier's rear legs 100c and 100d. However, as for the forward extendable portion 196, the cross member 198cd is not fixedly connected to the straddle carrier's rear legs. On the contrary, it is able to move up and down relative to the straddle carrier's legs, as the intermediate frame is raised and lowered by the winches 130. The slideable engagement between the cross member 198cd and the rails 102c and 102d associated with the rear legs, and the jaw-like configuration by which this slideable engagement is achieved, is the same as that described above for the forward extendable portion 196.

FIG. 3 to FIG. 10 illustrate the way the spreader 170 can extend and retract. For example, in FIG. 3 and FIG. 4, the spreader 170 is relatively retracted such that a 20 foot shipping container can connect thereto as pictured. In contrast, in FIG. 5 and FIG. 6, the spreader 170 is relatively extended such that a 40 foot shipping container can connect thereto as pictured. FIG. 9 also shows the spreader in a relatively retracted configuration, and FIG. 7, FIG. 8 and FIG. 10 show the spreader in a relatively extended configuration.

The spreader 170 itself comprises a central portion 172, and two extendable arm portions. One of the extendable arm portions 176 extends from, and retracts into, the forward end of the central portion 172, and the other of the extendable arm portions 178 extends from, and retracts into, the rearward end of the central portion 172. The central portion itself comprises two parallel, horizontal, rectangular through-channels 172l and 172r. A series of brackets 173 hold the two through-channels 172l and 172r together. The central portion 172 of the spreader (which comprises the two through-channels 172l and 172r) is suspended from the central structure of the intermediate frame 190. In this particular embodiment, the central portion 172 of the spreader hangs from the central structure of the intermediate frame by a series of short, fixed-length (i.e. non-length-adjustable) cables or chains. Hence, the spreader 170 is suspended from (i.e. it hangs from) the intermediate frame 190. The length of the cables/chains used for suspending the spreader 170 from the intermediate frame 190 should be kept short so as to prevent the spreader 170 (and any shipping container attached to the spreader) from swinging relative to the intermediate frame. However, the fact that the spreader 170 hangs from the intermediate frame by flexible cables/chains means that a small amount of forward and/or sideways movement of the spreader, relative to the intermediate frame, is possible.

Although not shown in the Figures, a mechanism (possibly a hydraulic mechanism comprising one or more hydraulic cylinders) may be provided between the spreader 170 and the intermediate frame 190. This may help to facilitate fine adjustment of the position of the spreader 170 relative to the intermediate frame 190. Where this mechanism comprises hydraulic cylinders, these hydraulic cylinders may include one or more of the following; a cylinder for shifting the spreader (plus the container if there is a container attached to the spreader) longitudinally relative to the intermediate frame; a cylinder for shifting the spreader (plus any container attached to the spreader) laterally/sideways relative to the intermediate frame; a cylinder (or multiple thereof) for adjusting the pitch and/or roll and/or yaw of the spreader (and of any container attached to the spreader) relative to the intermediate frame, etc. For example, if there is a container attached to the spreader, then the above mechanism may prove useful for fine adjustment of the container's position and orientation as the container is being placed precisely in position on the ground, or on top of another container, or as it is being loaded onto a vehicle such as a truck trailer or a railway car/carriage, etc. Alternatively, if there is not already a container attached to the spreader, then the above mechanism may prove useful for fine adjustment of the spreader's position and orientation relative to that of a container (this container may be on the ground, or on the back of a truck, etc) to precisely locate the spreader's attachment points relative to the appropriate positions where those attachment points connect to the container, so that the container can be attached and lifted, etc.

In the particular spreader 170 shown in FIG. 3 to FIG. 10, the extendable arm portion 176, which extends and retracts from the forward end of the central portion 172, is slidingly received in the forward end of right-hand through-channel 172r. Hence, the extendable arm portion 178, which extends and retracts from the rear end of the central portion 172, is slidingly received in the rearward end of left-hand through-channel 172l.

The extendable arm portions 176 and 178 of the spreader 170 both have an overall T-shaped configuration. In both cases, the long portion of the T (labelled 176x and 178x) comprises an elongate, structural “box section” member the inward end of which is slidingly inserted into the relevant through-channel (172r and 172l) in the spreader's central portion. And, on both of the arm portions 176 and 178, the short or “cross” portion of the T (labelled 176y and 178y) is mounted on the outward end of the T. The attachment points 177 where a shipping container can connect to the spreader are located on the underside at the ends of the respective “cross” portions 176y and 178y. There are therefore a total of four attachment points 177, one to attach to each of the top corners of a shipping container.

Typically, the spreader will be provided with an actuation system for extending and retracting the respective arms 176 and 178 relative to the central portion 172. The Figures do not necessarily show all of the components of this actuation system of the spreader, and those components of the actuation system which are visible are not individually labelled. Nevertheless, those skilled in the art will appreciate that any mechanism or system suitable for operating to extend and retract the spreader's arms 176/178 relative to the central portion 172 may be used. For example, an actuation system may be used that is hydraulic, pneumatic, electromechanical, a combination of these, etc. The actuation system will be controllable (e.g. typically from the driver's cabin) to extend/retract the spreader to the required length: e.g. to length required for a 20 foot container, or a 40 foot container. However, it is to be clearly understood that the spreader could also be extendable/retractable to other lengths too, enabling the spreader (and the straddle carrier generally) to be used to lift shipping containers of other sizes/dimensions (i.e. other than just standard 20 foot and 40 foot containers), or possibly even for lifting loads of other kinds (i.e. for lifting things other than shipping containers).

As discussed above, the large straddle carrier in FIG. 3 to FIG. 10 (and likewise in FIG. 11 to FIG. 13) is itself also able to extend and retract; that is, it is possible to controllably change the spacing between the front legs 100a/b and the rear legs 100c/d. The importance of this ability to adjust the spacing between the front legs 100a/b and the rear legs 100c/d can be readily appreciated from FIG. 3 to FIG. 6.

By way of further explanation, FIG. 3 and FIG. 5 both show the straddle carrier moving forward whilst carrying a shipping container. In FIG. 3, the shipping container being carried happens to be a 20 foot shipping container, whilst in FIG. 5 the shipping container being carried is a 40 foot container. As a consequence of this, FIG. 3 illustrates the spreader 170 in an unextended configuration suitable for carrying a 20 foot container, whereas FIG. 5 illustrates the spreader 170 in an extended configuration suitable for carrying a 40 foot container. However, apart from the different sized container being carried and the consequent different extension configuration of the spreader, FIG. 3 and FIG. 5 otherwise both show the straddle carrier in the same configuration. This is the configuration which the straddle carrier will typically adopt after it has picked up a shipping container, and when it is transporting or “driving” the shipping container from one location to another. It should be noted that, in this configuration, the overall straddle carrier is unextended (i.e. wheel-base shortened) such that the front legs 100a/b and rear legs 100c/d are as close together as they go. Furthermore, in this configuration, the wheeled bogie 120a (the bogie connected at the base of front left leg 100a) engages and connects/links rigidly together with the wheeled bogie 120c (the bogie connected at the base of rear left leg 100c). Likewise, the bogie 120b (the one connected at the base of front right leg 100b) engages and connects/links rigidly together with the bogie 120d (the one connected at the base of rear right leg 100d). The significance of the way the bogies can rigidly connect/link together, and the different possible configurations in which this can occur, will be discussed in further detail below.

In any case, in both FIG. 3 and FIG. 5, the front legs 100a/b and rear legs 100c/d are as close together as they go. In contrast to this, FIG. 4 and FIG. 6 both show the spacing between straddle carrier's front legs 100a/b and rear legs 100c/d increased in comparison, albeit that the increase in the spacing is greater in FIG. 6 than in FIG. 4. In FIG. 4, the straddle carrier is partially extended; that is, the front legs 100a/b are separated relative to the rear legs 100c/d by a distant sufficient to enable the front legs to move/pass down one side of a stack of 20 foot shipping containers while the rear legs move/pass down the other side of the said stack. As is evident from FIG. 4, it is important for the front legs to pass on one side of the stack whilst the rear legs pass on the other side of the stack, for example, so that the straddle carrier is able to position the container being carried directly on top of another similar container. Similarly, it will also be appreciated that, in the situation that the straddle carrier is not already carrying a shipping container, it may be important for the front legs to pass on one side of a container (or stack of containers) whilst the rear legs pass on the other side of the container (or stack of containers), for example, so that the spreader 170 can be correctly positioned to then be lowered (by the winches 130 etc) and for the attachment points 177 to attach to the respective four top corners of a container, in order for that container to be lifted.

FIG. 6 is similar to FIG. 4, except that in FIG. 6 the straddle carrier is fully extended (cf FIG. 4 where the straddle carrier is only partially extended). The reason the straddle carrier is fully extended in FIG. 6 is because the stack of shipping containers, and the shipping container being carried, are 40 foot containers rather than 20 foot containers.

The actual way in which the spacing between the straddle carrier's front legs 100a/b and rear legs 100c/d is varied (i.e. the way in which the overall straddle carrier is extended and retracted) is not critical to the invention and any suitable means for achieving this may be employed.

For example, a hydraulically actuated mechanical mechanism might be used. Such a hydraulic mechanism might involve, say, four hydraulic cylinders (not illustrated). One of these hydraulic cylinders might have one of its ends connected to the longitudinal beam 140a and its other end connected to the guide structure 150 on the outside of the through-channel 150a (this being the through-channel in the guide structure in which the longitudinal beam 140a is received). Similarly, another of the hydraulic cylinders might have one of its ends connected to the longitudinal beam 140b and its other end connected to the guide structure 150 on the outside of the through-channel 150b, etc. Hence, operating these hydraulic cylinders to lengthen/extend would force the respective longitudinal beams 140a-d to slide within their respective through channels 150a-d such that the spacing between the front legs and the rear legs increases. Alternatively, operating the hydraulic cylinders to shorten/retract would cause the respective longitudinal beams 140a-d to slide within their respective through channels 150a-d such that the spacing between the front legs and the rear legs reduces. Those skilled in the art will appreciate that, in order for hydraulic cylinders such as those just described to operate to extend/retract the straddle carrier, when the hydraulic cylinders are being operated to extend/retract, the wheels on the base of each of the straddle carrier's legs should be oriented to roll in a direction parallel to the straddle carrier's forward axis, and they should be “free” to roll (not locked or braked). This is so that the extension/retraction of the straddle carrier, by the hydraulic cylinders, is not prevented/inhibited by any of the wheels being locked against rotation, or by any of the wheels being oriented in the wrong orientation (i.e. pointing in the wrong direction).

Another possibility for extending and retracting the straddle carrier (i.e. for increasing/decreasing the space between the front and rear legs) might involve driving the straddle carrier's own wheels. As will be discussed further below, at least one wheel in each of the straddle carrier's bogies 120a-d will be a “driven” wheel. (Typically, each “driven” wheel will have an internal hydraulic motor to drive rotation of that wheel.) Therefore, because at least one of the wheels in each of the straddle carrier's bogies is driven, another way in which the spacing between the front and rear legs might be altered is to, for example, lock one or more wheels on each of the rear bogies against rotation (thus securing the rear bogies and the rear legs in position) and to then drive the wheels on the front bogies 120a and 120b such that the front bogies and the front legs move relative to (i.e. away from, or towards) the rear bogies and the rear legs. Obviously, driving the front bogies 120a and 120b away from the rear bogies would cause the spacing between the straddle carrier's front and rear legs to increase, whereas driving the front bogies 120a and 120b towards the rear bogies would cause the spacing between the front and rear legs to decrease. Also, it would be equally possible to lock one or more of the wheels on each of the front bogies and two drive the rear bogies (and hence the rear legs) relative to the front bogies (and the front legs). Furthermore, it may even be possible to drive both of the front bogies, and both of the rear bogies, at the same time.

The above method of altering the spacing between the straddle carrier's legs, namely by using the “driven” wheels to move the front and/or rear bogies relative to one another, might even be used in combination with the system of hydraulic cylinders discussed above. Therefore, for example, the straddle carrier might have a system of hydraulic cylinders as discussed above, and when the hydraulic cylinders are operated to extend/retract thereby slidingly extending/retracting the longitudinal beams 140a-d relative to the guide structure 150, at the same time the driven wheels on the front and/or rear bogies may also be driven in the appropriate direction. This may help to prevent undesirable stresses, bending, flexure, etc, in the straddle carrier by ensuring that the spacing between the tops of the straddle carrier's front and rear legs remains the same, and changes at the same rate, as the spacing between the bottoms of the straddle carrier's front and rear legs.

A number of possibilities are discussed above for the way in which the spacing between the straddle carrier's front legs 100a/b and rear legs 100c/d might be varied. However, these are discussed merely as possible examples, and the invention is not limited in any way to or by these. Therefore, as mentioned above, any other suitable mechanism for extending/retracting the straddle carrier may be used.

As has been discussed, the straddle carrier itself (i.e. the spacing between the straddle carrier's front and rear legs) can be extended and retracted. It has also been discussed that the straddle carrier's spreader 170 is able to extend and retract. However, it is important to understand that extension/retraction of the spreader 170 is entirely independent of the extension/retraction of the straddle carrier itself. Hence, it is perfectly possible for the spreader to adopt an extended configuration even when the straddle carrier itself is unextended. In fact, FIG. 5 is an illustration of this. Similarly, it is perfectly possible for the spreader to adopt an unextended configuration even when the straddle carrier itself is partly or fully extended. In this regard, FIG. 4 illustrates the spreader 170 in the retracted configuration (suitable for carrying a 20 foot container) even though the straddle carrier itself is partially extended.

As has been mentioned previously, in the large straddle carrier in FIG. 3 to FIG. 10 (and likewise for the large straddle carrier in FIG. 11 to FIG. 13) there is a wheeled bogie 120 attached to the base of each of the straddle carrier's legs. The bogie attached to the base of the straddle carrier's front left leg 100a is bogie 120a, the bogie attached to the base of the front right leg 100b is the bogie 120b, etc.

In the large straddle carrier in FIG. 3 to FIG. 10 (and likewise the large straddle carrier in FIG. 11 to FIG. 13) each of the bogies 120a-d has two wheels. (In other embodiments, each of the bogies, or some of them, might be provided with a greater number of wheels.) The reason why it is important for each of the bogies have two (or more) wheels is generally similar to the reason explained above with reference to the straddle carrier in FIG. 2. That is (just like for the straddle carrier in FIG. 2) the wheels of the straddle carrier in FIG. 3 to FIG. 10 (and in FIG. 11 to FIG. 13), and even wheels which are connected to the same bogie, are separated from each other by an appreciable distance. The reason for the separation (i.e. distance) between individual wheels is to distribute the straddle carrier's load over a greater number of separated (i.e. spaced apart) contact points, such that each individual contact point bears less of the overall load, thus reducing the propensity for damage to the concrete surface on which the straddle carrier operates.

In the embodiments in FIG. 3 to FIG. 10 and FIG. 11 to FIG. 13, the wheels on the respective bogies support the bogies on the ground, and the bogies together in turn support the full weight of the rest of the straddle carrier (and its load). In the embodiments discussed herein, each of the wheels includes a rubber tyre (typically, although not necessarily exclusively, a pneumatic tyre) for providing grip/traction.

It has been mentioned that, typically, at least one wheel on each of the bogies 120a-d will be a driven wheel. Each driven wheel may be provided with an internal hydraulic motor to drive rotation of that wheel (although other means for imparting rotation into the “driven” wheels may also be used). It is possible that, for all or some of the bogies, both of the wheels of the bogie might be driven, or in embodiments where bogies includes a greater number of wheels, some or all of the wheels of each bogie may be driven. In any case, whilst this is possible, it is envisaged that normally only one of the wheels on each bogie will be a driven wheel.

Whilst it may often be the case that only one of the wheels on each bogie is a driven wheel, it is important for all wheels on all of the bogies to be turnable/steerable (regardless of the number of wheels per bogie). Obviously, the various wheels will not all always turn/steer by the same amount at the same time. Indeed, it will often be necessary for some wheels to turn by a different amount compared to others in order for the straddle carrier to steer or track correctly. Nevertheless, it is important for all of the wheels of all of the bogies to be able to be turned/steered. One particular reason why this is important will be more easily understood from the discussion below of the way in which the bogies can pivot relative to the respective legs of the straddle carrier, and the consequences of this. The actual way in which each of the straddle carrier's wheels is turned/steered is not critical to the invention. Therefore, any means for turning/steering each of the straddle carrier's wheels may be used.

Typically, each of the straddle carrier's wheels will be mounted to its bogie in such a way that that wheel can pivot relative to its bogie about a vertical axis. This applies for both driven and non-driven wheels. On each bogie, the various wheels might also be turnable/steerable independently of the other wheel(s) on that bogie. Alternatively, mechanisms or systems might be provided which operate such that, on each bogie, the turning/steering of one wheel on that bogie is related/linked to the amount by which other wheel(s) on that bogie turn/steer.

One of the important functionalities of the large straddle carrier in FIG. 3 to FIG. 10 (and likewise the large straddle carrier in FIG. 11 to FIG. 13) is that each of the bogies 120a-d is able to pivot by at least 90° in the horizontal plane relative to the leg to which it is attached. In other words, each of the bogies 120a-d is able to pivot horizontally relative to its respective leg 100a-d by at least 90°. Hence, bogie 120a is able to pivot horizontally by at least 90° relative to leg 100a, bogie 120b is able to pivot horizontally by at least 90° relative to leg 100b, etc. This ability of the bogies to pivot relative to their respective legs can be appreciated by comparing FIG. 3 with FIG. 4, and likewise by comparing FIG. 5 with FIG. 6.

In FIG. 3 and FIG. 5, the bogies 120a-d are oriented parallel to the straddle carrier's forward axis. That is to say, bogies 120a and 120c are aligned such that their respective wheels form a single line parallel to the straddle carrier's forward axis. The same is true of bogies 120b and 120d, the wheels of which also form a single line parallel to the straddle carrier's forward axis. When the bogies 120 are arranged relative to one another in this way (i.e. as shown in FIG. 3 and FIG. 5) this is the configuration which the straddle carrier will typically adopt, after it has lifted a shipping container, to “drive” the shipping container from one location to another.

In contrast, in FIG. 4 and FIG. 6, the bogies 120a-d are oriented perpendicular to the straddle carrier's forward axis. That is to say, bogies 120b and 120a are aligned such that their respective wheels form a single line perpendicular to the straddle carrier's forward axis. The same is true of bogies 120d and 120c, the wheels of which also form a single line perpendicular to the straddle carrier's forward axis. When the bogies 120 are arranged relative to one another in this way (i.e. as shown in FIG. 4 and FIG. 6) these are configurations which the straddle carrier can adopt, for example, if it is required to place a shipping container on top of another shipping container, or to lift a shipping container off the top of another container (or off a stack of other containers), in circumstances where it is not possible for the straddle carrier to drive lengthwise over the top of the said other shipping container(s) due to the presence of yet other nearby containers or other obstacles. These configurations (i.e. as shown in FIG. 4 and FIG. 6) might also be used in circumstances where (even absent other obstacles) there is not enough space/room in a given area for the straddle carrier to drive into the area forwards/lengthwise (or there is not enough room for the container to be placed lengthwise), but it is nevertheless possible to drive the straddle carrier into the said area sideways (or the space would permit a container to be placed therein sideways).

To understand this more clearly, consider again the mini straddle carrier depicted in FIG. 2. The mini straddle carrier in FIG. 2, even if it were high enough to lift one container off another (or to place one container on top of another), which it is not, nevertheless that straddle carrier still could not perform the functions being depicted in FIG. 4 and FIG. 6. This is because, with the straddle carrier in FIG. 2 (even if it were high enough), before that straddle carrier could lift a shipping container off a lower container (or place a container on top of a lower container down) the straddle carrier would first need to drive forward over the lower container in the containers' lengthwise direction. However, in FIG. 4 and FIG. 6, this would not be possible due to the presence of other containers which are stacked too closely nearby, and which therefore would not allow the straddle carrier to drive forward over the lower container in the lower containers' lengthwise direction. In other words, in FIG. 4 and FIG. 6, the other containers stacked nearby are too close and would not allow the straddle carrier of FIG. 2 (even if it were high enough) to position itself over the top of the containers (or over the lower container) to lift off the top container (or to place a container on top of the lower container). This is something which can, however, be achieved with straddle carriers in accordance with embodiments of the present invention, such as the large straddle carriers illustrated in FIG. 3 to FIG. 10 and FIG. 11 to FIG. 13.

The ability to perform operations such as those depicted in FIG. 4 and FIG. 6 (and other similar operations) may make straddle carriers in accordance with embodiments of the invention more versatile than traditional straddle carriers. The significance of this can perhaps be even more fully appreciated when the operation of straddle carriers according to the present invention is considered in the context of a typical storage yard.

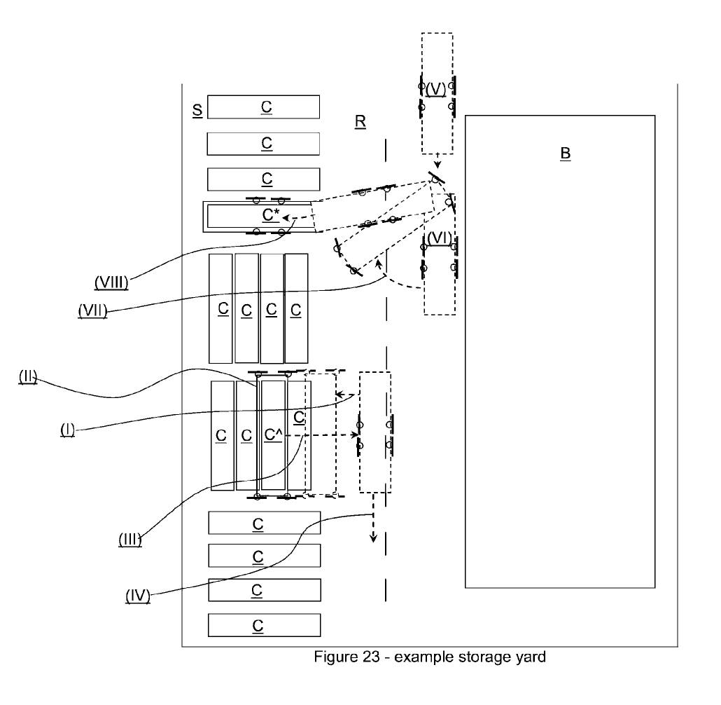

FIG. 23 is an illustration of a typical storage. In fact, the storage yard in FIG. 23 is almost identical to the storage yard in FIG. 1. That is, in FIG. 23, the size of the building B, the amount of space occupied by the road R and the amount of space S available for storing containers C are substantially the same as in FIG. 1. However, it will be immediately appreciated that, in FIG. 23, the shipping containers are stored in a much more compact/dense arrangement, and consequently the number of shipping containers that can be stored in the area S is considerably higher than in FIG. 1. With many traditional straddle carriers (like the one illustrated in FIG. 2 for example) it simply would not be possible to store containers in an arrangement like that shown in FIG. 23. This is because it simply would not be possible for a straddle carrier like the one in FIG. 2 to place containers in the positions which they occupy in FIG. 23. Nor would a straddle carrier like the one in FIG. 2 be able to place containers as closely together as in FIG. 23.

Storage of containers in a more compact arrangement, like that illustrated in FIG. 23 for example, may be possible using straddle carriers in accordance with embodiments of the present invention. FIG. 23 contains two examples that help to demonstrate how this may be so.

In a first example in FIG. 23, let it be assumed that the particular container indicated as Ĉ is to be retrieved from storage in area S. (Container Ĉ might be thought of as resting directly on the ground in between other containers C (or stacks of containers C), or alternatively it might be the top container on a stack of containers with the said stack being in between other containers C (or stacks of containers C).) As those skilled in the art will appreciate, it would not be possible to retrieve the container Ĉ using a straddle carrier like the one in FIG. 2. This is because, even if the container Ĉ is a single container resting directly on the ground, nevertheless due to the other containers (or stacks of other containers) C in the vicinity, there is far too little room for a straddle carrier like the one in FIG. 2 to drive lengthwise over the top of container Ĉ in order to pick it up.

However, it would be possible for a straddle carrier in accordance with the present invention (like the large straddle carrier in FIG. 3 to FIG. 10) to navigate between the other containers in order to pick up container Ĉ. In fact, if it is assumed that the containers in FIG. 23 are all 40 foot containers, a straddle carrier in accordance with the present invention, like the straddle carrier in FIG. 3 to FIG. 10, could be appropriately configured to retrieve the container Ĉ if it were to change from the configuration illustrated in FIG. 3/FIG. 5 into the configuration illustrated in FIG. 6 (except that, whereas FIG. 3/FIG. 5/FIG. 6 illustrate the straddle carrier already carrying a container, the straddle carrier would not generally be already carrying a container before picking up container Ĉ). It will be appreciated that if the straddle carrier were to first change from the configuration illustrated in FIG. 3/FIG. 5 into the configuration in FIG. 6 whilst still on the road R, it could then move sideways off the road, passing over the intervening container (or stack) C which is closest to the road as indicated by (I) in FIG. 23. It could then position itself over the container Ĉ as shown at (II). The straddle carrier could then connect to and lift the container Ĉ. Importantly, it would need to lift container Ĉ to a height higher than that of the intervening container (or stack) C which is closest to the road. Once the container Ĉ has been lifted to the necessary height to clear the intervening container/stack, the straddle carrier (whilst carrying container Ĉ at the necessary height) could then move back sideways towards the road as indicated by arrow (III). Upon again reaching the road, the straddle carrier could next reconfigure itself (whilst still carrying container Ĉ) to adopt the configuration illustrated in FIG. 5 (this being the configuration suitable for “driving”). The straddle carrier could then be used to transport the container Ĉ down the road R (as indicated by (IV)) to wherever it needs to go.

Of course, the process described above ((I) to (IV)) could simply be reversed if it were necessary to place a container onto the position of container Ĉ in FIG. 23.

In a second example in FIG. 23, let it be assumed that a container is to be placed in the position marked C*. The position indicated C* in FIG. 23 is actually a similar position and orientation to the container labelled C′ in FIG. 1. However, as explained with reference to FIG. 1, the position and orientation of container C′ in FIG. 1 is actually not one which a shipping container could be placed in using a straddle carrier like the one depicted in FIG. 2. This is because, as indicated by arrow (i) in FIG. 1, if a container were to be in this position and orientation, it would not be possible for a straddle carrier like the one in FIG. 2 to retrieve it as there is not enough room between the container C′ and the building B for the straddle carrier to pick up the container C′ and then make the turn onto the road R. (It therefore would not be possible, in that example, for the container C′ to even be placed in that position to start with using a straddle carrier like the one in FIG. 2 which has a large turning circle.)

However, placing a container in the position marked C* in FIG. 23 may be quite possible using a straddle carrier in accordance with an embodiment of the present invention, like the one in FIG. 3 to FIG. 10. To do so, a container could initially be driven down the roadway by the straddle carrier, as indicated by (V) and (VI) in FIG. 23. At this point the straddle carrier would be configured and carrying the container, as in FIG. 5. The straddle carrier could then “extend” so that the spacing between its front and rear legs increases. This extension might occur whilst straddle carrier is still carrying (i.e. lifting and suspending) the container. The bogies on the ends of the straddle carrier's respective legs might next each rotate relative to its leg, such that each bogie (and the individual wheels of each respective bogey) become oriented, as represented in FIG. 23, to enable the straddle carrier (whilst still carrying the container) to turn in an arc about one end of the straddle carrier, as shown. In other words, the straddle carrier may thus turn, as indicated by (VII), with one end of the straddle carrier (mostly) just pivoting about its current position and the other end sweeping around in an arc. Finally, the straddle carrier could then reconfigure into the “driving” configuration of FIG. 5 and then drive and steer into the position marked C*, as indicated by (VIII), thus placing the container in the position marked C* as required.

Mention has been made above of the way in which, in the straddle carrier in FIG. 3 to FIG. 10, the individual bogies 120a-d are able to pivot by at least 90° relative to their respective legs 100a-d. Indeed, FIG. 3 and FIG. 5 illustrate the straddle carrier with the bogies oriented parallel to the straddle carrier's forward direction, whereas FIG. 4 and FIG. 6 illustrate the straddle carrier with the bogies oriented perpendicular to the forward direction. A discussion will now be given of how the respective bogies might pivot.

It has been mentioned previously that, typically, at least one of the wheels on each bogie will be a “driven” wheel (e.g. with a hydraulic motor for driving rotation of that wheel). It has also been mentioned previously that all of the wheels on each bogie should be turnable, relative to the bogie about a vertical axis, so as to be steerable. Accordingly, one way that the respective bogies might be caused to pivot relative to their respective legs would be for the wheels on each bogie to first pivot relative to the bogie (i.e. to steer) so as to become oriented substantially perpendicular to the bogie itself. In other words, each of the wheels should steer so that it is oriented such that, if that wheel were to roll, it would roll in a direction perpendicular to the lengthwise axis of its bogie. After all of the wheels have been turned relative to their respective bogies in this manner, the driven wheel(s) on each bogie could then be “driven” (i.e. caused to rotate/roll) in the appropriate direction such that the bogies are thereby caused to pivot (i.e. rotate in the horizontal plane about a vertical axis) relative to their respective vertical legs. The legs themselves will typically remain stationary. Therefore, apart from the pivoting movement of the respective bogies, the straddle carrier would typically otherwise remain motionless during this process.

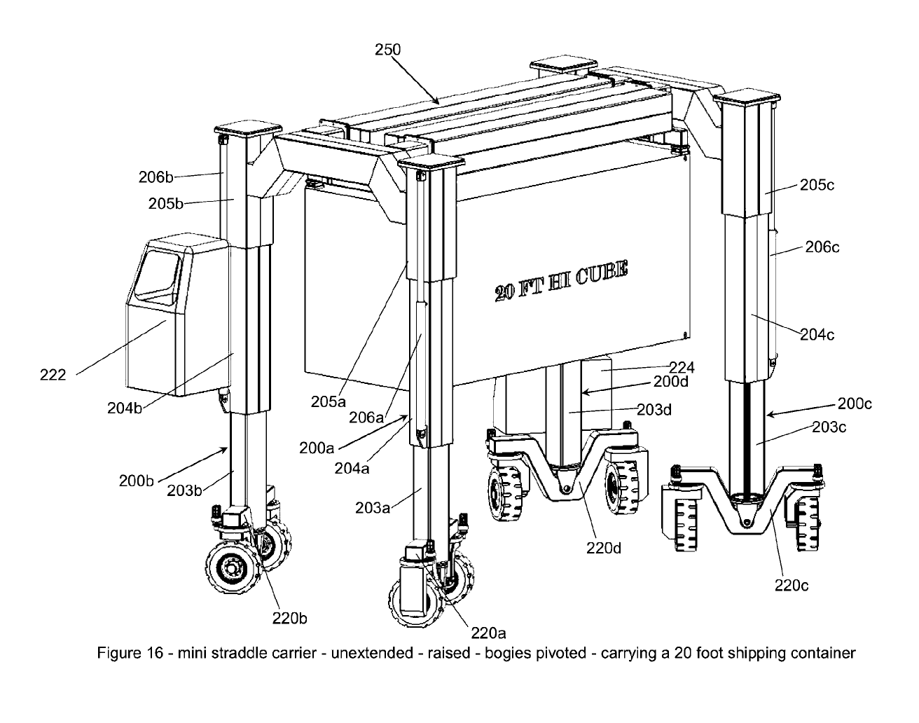

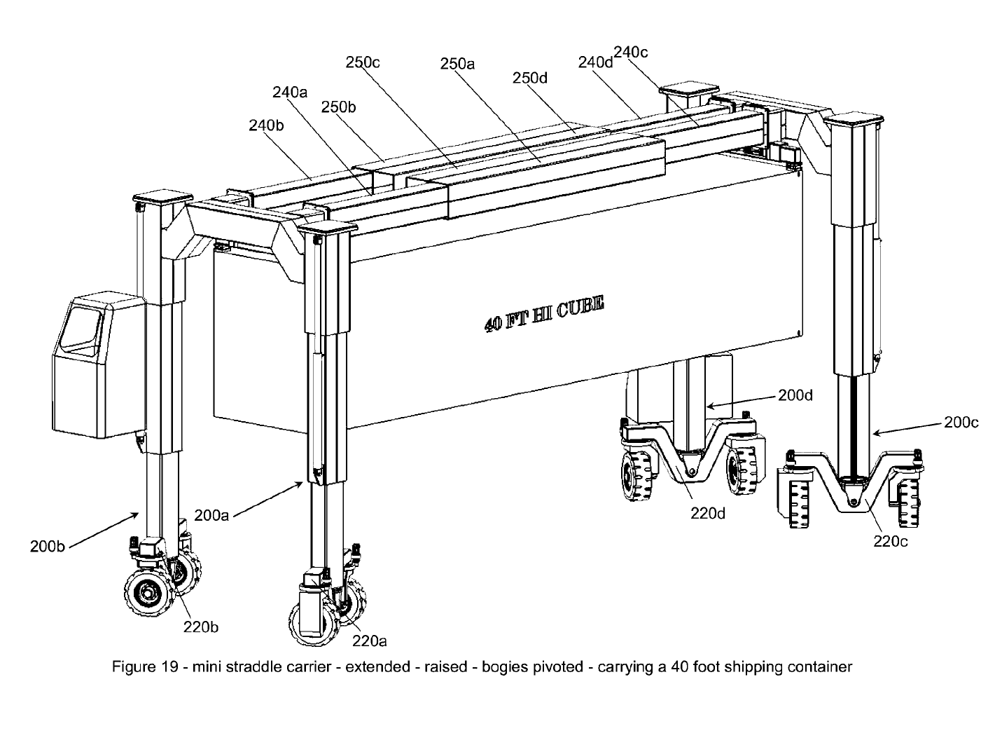

None of FIG. 3 to FIG. 10 illustrate the wheels in an orientation what that would allow the respective bogies to pivot relative to the respective legs in the manner just described. However, an illustration of this is given in FIG. 16 and FIG. 19 in the context of a possible mini straddle carrier embodiment of the invention (discussed below). So, the way the wheels can be turned/steered relative to their respective bogies (i.e. so as to be pointed perpendicular to the lengthwise axis of their respective bogies, as discussed above), and the way that the driven wheel(s) on each bogie can then be driven to pivot the respective bogies relative to their respective legs, can be appreciated from FIG. 16 and FIG. 19. Those skilled in this area will be able to understand, from FIG. 16 and FIG. 19, how the same principles of operation could be applied in the large straddle carrier in FIG. 3 to FIG. 10.

FIG. 11 to FIG. 13—large straddle carrier in accordance with another possible embodiment

Turning now to FIG. 11 to FIG. 13, as mentioned above, these Figures illustrate another possible embodiment of the invention. In this embodiment, the straddle carrier is again a large straddle carrier, but its configuration is slightly different to the large straddle carrier in FIG. 3 to FIG. 10.

For ease of reference and consistency, features of the large straddle carrier in FIG. 11 to FIG. 13 which correspond to equivalent features of the large straddle carrier in FIG. 3 to FIG. 10 will be identified using the same reference numerals.

One of the ways that the large straddle carrier in FIG. 11 to FIG. 13 differs from the one in FIG. 3 to FIG. 10 is that, whereas in FIG. 3 to FIG. 10 the through-channels 150c and 150d (on either side of the central guide structure 150) are located vertically beneath the through-channels 150a and 150d respectively, in FIG. 11 to FIG. 13 the equivalent through-channels 150c and 150d are positioned at the same vertical height as, but on the outside of, the through-channels 150a and 150b respectively. Accordingly, in FIG. 11 to FIG. 13, all four of the longitudinal beams 140a-d are located at the same vertical height, and the longitudinal beams 140c and 140d associated with the rear legs 100c and 100d are positioned on the outside of the longitudinal beams 140a and 140b associated with the front legs 100a and 100b. This also means that, in FIG. 11 to FIG. 13, all four of the straddle carrier's legs 100a-100d are of the same vertical length.

As a result of differences like those just mentioned, the configuration of the straddle carrier in FIG. 11 to FIG. 13 is slightly different in appearance to the configuration of the straddle carrier in FIG. 3 to FIG. 10. However, these kinds of differences do not significantly affect the way the straddle carrier in FIG. 11 to FIG. 13 functions vis-à-vis the straddle carrier in FIG. 3 to FIG. 10 in most respects. In other words, despite these visually apparent configurational differences, the overall way that the straddle carrier in FIG. 11 to FIG. 13 functions is substantially the same as the straddle carrier in FIG. 3 to FIG. 10 in most respects. For instance, the following functionalities are generally the same between the two: the way the straddle carrier can be extended/retracted to alter the distance between the front legs 100a/b and the rear legs 100c/d; the way that the spreader 170 is connected to the guide structure 150 via an intermediate frame 190; the way that the intermediate frame 190 is slidingly engaged with vertical rails 102a-d associated with each of the respective legs 100a-d to allow the intermediate frame 190 to be raised and lowered by the winches; etc. These features and functionalities of the straddle carrier in FIG. 11 to FIG. 13, as well as other features and functionalities which those skilled in the art will recognise as common with straddle carrier in FIG. 3 to FIG. 10, therefore need not be explained any further.

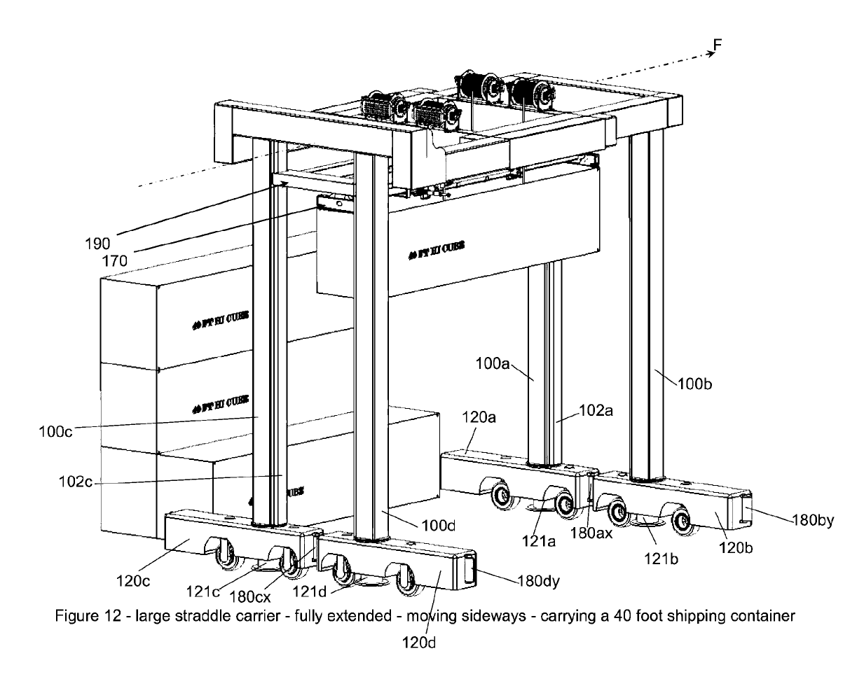

It will be appreciated that FIG. 11 is similar to FIG. 3 (discussed above) in that it shows the large straddle carrier (in this alternative embodiment) carrying a 20 foot shipping container and the straddle carrier is travelling in a “forward” direction (or at least in a direction parallel to the straddle carrier's “forward” axis F). Similarly, FIG. 12 is similar to FIG. 6 (discussed above) in that it shows the large straddle carrier (in this alternative embodiment) carrying a 40 foot shipping container, and to help provide context, it illustrates how the large straddle carrier might be used to place a shipping container on, or retrieve a shipping container from, a stack of other like shipping containers.

It will also be noted that, in FIG. 11, the straddle carrier's bogies 120a-d are all oriented parallel to the straddle carrier's forward axis. As explained above, when the bogies 120 are arranged relative to one another in this way (i.e. as shown in FIG. 11) this is the configuration which the straddle carrier will typically adopt, after it has lifted a shipping container, to “drive” the shipping container from one location to another. In contrast, in FIG. 12, the bogies 120a-d are oriented perpendicular to the straddle carrier's forward axis. When the bogies 120 are arranged relative to one another in this way (i.e. as shown in FIG. 12) this is a configuration which the straddle carrier can adopt, for example, if it is required to place a shipping container on top of another shipping container, or to lift a shipping container off the top of another container (or off a stack of other containers), in circumstances where it is not possible for the straddle carrier to drive lengthwise over the top of the said other shipping container(s) due to the presence of yet other nearby containers or other obstacles. This configuration (i.e. as shown in FIG. 12) might also be used in circumstances where (even absent other obstacles) there is not enough space/room in a given area for the straddle carrier to drive into the area forwards/lengthwise (or there is not enough room for the container to be placed lengthwise), but it is nevertheless still possible to drive the straddle carrier into the said area sideways (or the space would permit a container to be placed therein sideways).

However, one important difference between the straddle carrier in FIG. 11 to FIG. 13 and the straddle carrier in FIG. 3 to FIG. 10 relates to the way the bogies 120a-d are able to pivot relative to their respective legs 100a-d. In the embodiment in FIG. 3 to FIG. 10 discussed above, pivoting of the bogies 120a-d was achieved by first turning/steering the wheels on each bogie so as to each point perpendicular to the bogie, and then using each bogie's driven wheel(s) to impart pivoting motion to the bogie (i.e. to pivot each bogie in a horizontal plane relative to its associated vertical leg). This is NOT how the bogies 120a-d in the embodiment in FIG. 11 to FIG. 13 pivot relative to their respective legs. Rather, in the embodiment in FIG. 11 to FIG. 13, an alternative means is provided for pivoting the bogies relative to the legs.

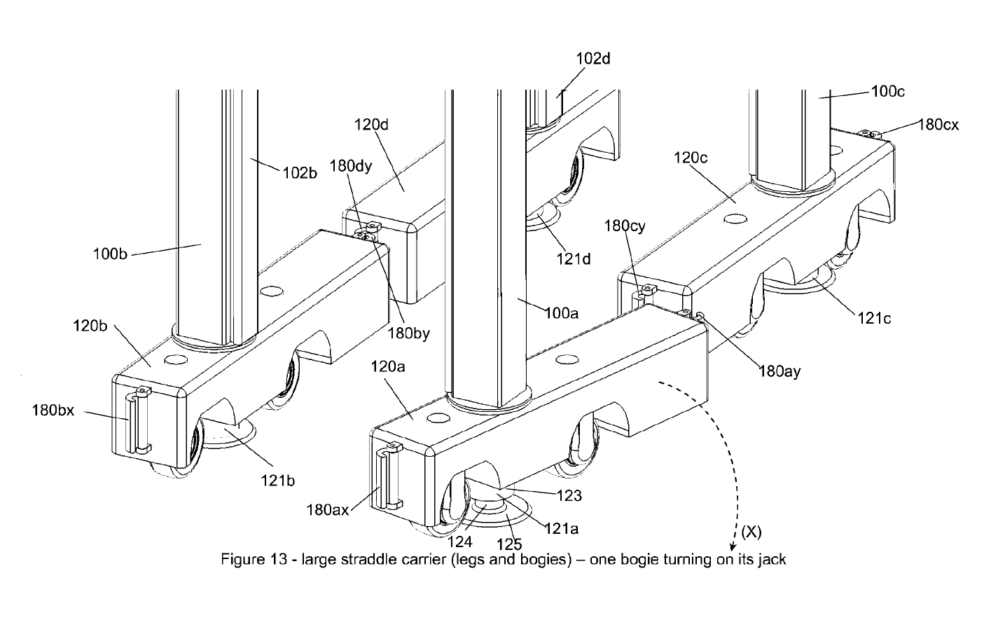

In the embodiment in FIG. 11 to FIG. 13, each of the bogies is provided with a jack mechanism 121. The jack mechanism associated with bogie 120a is labelled 121a, the jack mechanism associated with bogie 120b is labelled 121b, etc. The bogies 120a-d, with their respective jack mechanisms 121a-d, are most clearly visible in FIG. 13.

In FIG. 13, only the jack mechanism 121a associated with bogie 120a is shown in operation. Hence, FIG. 13 illustrates the way the bogie 120a can be lifted and pivoted relative to the leg 100a. (The jack mechanisms 121b-d etc associated with the other three bogies operate in the same way, but these are not shown in use in FIG. 13 and their parts are not individually labelled.)

Referring to the jack mechanism 121a associated with bogie 120a, it will be seen that this mechanism includes a main cylindrical housing 123. Part of the housing 123 is actually contained inside the bogie 120a, although part of the housing 123 also visibly projects below (and externally of) the underside of the bogie. Typically, the jack mechanism 121a (and likewise the other jack mechanisms 121b-d) will be hydraulically operated and many of the hydraulic components and connections (not pictured) will be contained within the housing 123.

FIG. 13 illustrates that the jack mechanism 121a includes a lifting pillar 124, and on the lower end of the lifting pillar 124 there is a circular, disc-like foot 125 which is operable to contact directly with the ground when the lifting pillar 124 is lowered. When the jack mechanism 121a is operated to lift the bogie 120a, the mechanism's hydraulics are first operated to lower the pillar 124 such that it begins to move downward from the lower end of the housing 123 until the foot 125 contacts the ground. Once the foot 125 contacts the ground, the mechanism's hydraulics continue to drive the pillar 124 downward, but because the foot 125 is then pressing directly against the (solid and immovable) ground, the effect of this is that the housing 123 is instead driven vertically upwards. It will be appreciated that, because the housing 123 is connected to (mounted within the structure of) the bogie 120a, it follows that when the housing 123 is driven upward, this in turn causes the bogie 120a (including its wheels, etc) to be lifted vertically off the ground. The leg 100a which is supported on top of the bogie 120a would, of course, also be lifted as a result of this. Note that the jack mechanism 121a does not need to lift the bogie 120a (and its wheels, etc) very far off the ground; only far enough that the bogie 120a can pivot relative to the ground in a horizontal plane without its wheels or any other part of it contacting or dragging along the ground.

In any case, after the jack mechanism 121a has been operated to lift the bogie 120a clear of the ground, a pivoting mechanism (not pictured) which is associated with the jack mechanism 121a can then be operated to cause the bogie 120a to pivot in a horizontal plane relative to the leg 100a. In FIG. 13, this horizontal pivoting movement of the bogie 120a is represented by arrow (X). Of course, the pivoting mechanism associated with the jack mechanism may be operated to pivot the bogie in either direction (i.e. in either a clockwise direction (arrow (X)) or an anticlockwise direction (opposite to arrow (X)) when viewed from above).

As mentioned above, the jack mechanisms 121b-d associated with the respective bogies 120b-d, and also the pivoting mechanisms (not pictured) associated with each, operate in the same way as described above. This is therefore how the bogies 120a-d can be pivoted relative to the respective legs 100a-d in the embodiment in FIG. 11 to FIG. 13.

Another important feature illustrated in FIG. 11 to FIG. 13 is the means by which different bogies are able to be rigidly connected/linked together in different configurations. In the embodiment in FIG. 11 to FIG. 13, this means takes the form of a mechanism in which there is a curved catch arm on either end of each of the respective bogies. However, this is merely an example, and for the avoidance of doubt, any kind of mechanism, system or other means which is able to allow different bogies to be rigidly connected/linked together in different configurations (as discussed below) may be used in embodiments of the invention.

In the example in FIG. 11 to FIG. 13, where the mechanism for rigidly connecting the various bogies to one another (in different alternative configurations) comprises a curved catch arm on each end of each bogie, the catch arm on the end of bogie 120a that is closer to the leg 100a is labelled 180ax and the catch arm on the end of bogie 120a that is further from the leg 100a is labelled 180ay. Similarly, the catch arm on the end of bogie 120b that is closer to the leg 100b is labelled 180bx and the catch arm on the end of bogie 120b that is further from the leg 100b is labelled 180by, etc.

The catch arms on the ends of the respective bogies all have the same configuration. Each one (i.e. each catch arm) has one edge thereof hingedly mounted to its end of the relevant bogie. Each catch arm is therefore able to pivot/swing about the vertical axis of its hinged connection to the bogie. Each of the catch arms is also curved. The curved shape of the catch arms remains constant along the catch arms' full vertical length. In every case, the curvature of the catch arm is a “right-handed” curve. What is meant by this is that, the curvature of each catch arm is the same as the curvature of a partly-closed (or relaxed) human right hand, if the human right hand were to be positioned with the thumb pointing upward, with the wrist notionally positioned where the catch arm's hinge is (on an end of one of the bogies) and with the right hand then pointing “fingers-outward” away from the relevant end of the bogie. (As an aside, this particular mechanism would also work if all of the catch arms were to instead have a left-handed curvature, assuming the catch arm design remained otherwise the same.)

The way that the various catch arms allow the different bogies to be connected/linked together in different configurations can be understood, firstly, from FIG. 13. In FIG. 13, the bogies 120a-d are positioned relative to one another in the same way as in FIG. 11, except for bogie 120a which is shown slightly pivoted in comparison, and FIG. 11 shows the same general bogie configuration as FIG. 3 and FIG. 5. In this bogie configuration, it can be seen for example that the bogie 120b is aligned with the bogie 120d. More specifically, with these two bogies (120b and 120d) in this position relative to one another, the catch arms 180by and 180dy of these two respective bogies can thus be brought together and pivoted such that they engage with, and connect to, one another. When the two catch arms are engaged with one another in this way, this creates a rigid connection/link between the two bogies.

To understand further the way the catch arms can operate, imagine if in FIG. 13 the bogie 120a were to pivot from the position in which it is shown and back in the opposite direction to arrow (X) until the bogie 120a is aligned/parallel with the bogie 120c. Assume also that the jack 121a is then retracted such that the bogie 120a is not only aligned with the bogie 120c (parallel to the straddle carrier's forward axis) but it also has its wheels in full weight-bearing contact with the ground. After the bogie 120a has been moved into this position as just described, the catch arm 180ay on bogie 120a and the adjacent catch arm 180cy on adjacent bogie 120c can then pivot/swing toward each other and engage with one another (i.e. in the same manner as is depicted for the catch arms 180by and 180dy in FIG. 13). As has been described, this engagement between catch arms creates a rigid connection between the two associated bogies. More specifically, while the two bogies are linked by this rigid connection, those bogies effectively become a single rigid bogie, by which it is meant that one of the bogies cannot separate from the other, or move one way or laterally relative to the other, etc.

It will be noted that when two of the straddle carrier's bogies are connected to one another, the straddle carrier's other two bogies will typically also be connected to one another at the same time. However, whenever this is the case, only one of the catch arms on each bogie is involved in forming the connection with the other relevant bogie. On the other hand, from FIG. 13, it will be seen that there is a catch arm on both ends of each of the bogies. The reason why there is a catch arm on both ends of each of the bogies is so that the bogies are not only able to connect with one another in the bogie configuration of FIG. 3/FIG. 5/FIG. 11, but also in the alternative bogie configuration of FIG. 4/FIG. 6/FIG. 12. To explain this further, it will be appreciated that in the bogie configuration of FIG. 3/FIG. 5/FIG. 11, the catch arms 180ay and 180cy engage with one another to rigidly connect bogies 120a and 120c together. Likewise, in the bogie configuration of FIG. 3/FIG. 5/FIG. 11, the catch arms 180by and 180dy engage with one another to rigidly connect bogies 120b and 120d together. However, in the alternative bogie configuration of FIG. 4/FIG. 6/FIG. 12, the catch arms 180ax and 180bx engage with one another to rigidly connect bogies 120a and 120b together, and the catch arms 180cx and 180dx engage with one another to rigidly connect bogies 120c and 120d together.

It will be appreciated that, if two bogies are connected to one another, it is possible to disconnect one of those in bogies from the other. If the particular example mechanism for connecting bogies illustrated in FIG. 11 to FIG. 13 is used, this can be done by simply pivoting/swinging the two catch arms (i.e. the two that form the connection between the two said bogies) away from one another so that the catch arms disengage. There are a number of reasons why it may be necessary to disengage one bogie from another. For example, this is necessary if the straddle carrier itself is to be extended/retracted (i.e. the spacing between the straddle carrier's front and rear legs is to be increased/decreased). Logically, the straddle carrier's front bogies 120a/b cannot be moved relative to the rear bogies 120c/d (as is necessary to change the spacing between the front and rear legs) unless the bogie 120a is separated from the bogie 120c and the bogie 120b is separated from the bogie 120d. Also, if the straddle carrier's bogie configuration is to be changed from the bogie configuration of FIG. 3/FIG. 5/FIG. 11 (bogies parallel to the forward axis) into the alternative bogie configuration of FIG. 4/FIG. 6/FIG. 12 (bogies perpendicular to the forward axis), or vice versa, the bogies will obviously need to be disengaged from one another before the individual bogies can be pivoted relative to their respective legs in order to perform this reconfiguration.

It is also to be clearly understood that, even though only FIG. 11 to FIG. 13 illustrate a mechanism for creating rigid connections between bogies of a large straddle carrier (in different bogie configurations), nevertheless a similar mechanism, or at least a mechanism or system for performing the same function, may (and probably would) also be incorporated into the embodiment of the large straddle carrier in FIG. 3 to FIG. 10. The reason why a mechanism for rigidly connecting/linking bogies of a large straddle carrier together may be important is due to the size/scale of large straddle carriers, and the magnitude of the loads. To give a general indication, the large straddle carrier embodiments depicted in FIG. 3 to FIG. 10 and FIG. 11 to FIG. 13 might be approximately 12 m high, and it is possible for a 40 foot container to weigh over 30,000 kg (30 tonnes)—and this does not include the weight of the straddle carrier itself (which may be an additional several tonnes). Therefore, given the size of the structure, and the magnitude of the loads involved, if the individual bogies of the large straddle carrier were to remain separated/unconnected from one another when the straddle carrier is driving and carrying a heavy container (irrespective of whether the straddle carrier is driving in a direction generally parallel to forward axis F, or a direction generally perpendicular thereto), this could lead to flexure of the straddle carrier, or undesirable movement or relative displacement of some bogie(s) relative to other(s), and these sorts of things might possibly lead to instability and/or damage and/or structural fatigue. However, if a mechanism is provided for rigidly connecting/linking bogies together, as explained above, these potential problems may be alleviated or at least reduced.

Another point to note is that, even though respective pairs of the large straddle carrier's bogies may be connected/linked together when the straddle carrier is driving, it is still possible for the individual wheels of the bogies to be steered whilst driving. Therefore, even though the bogies are rigidly connected together, it is still possible for the straddle carrier to steer whilst driving (i.e. the straddle carriers not restricted to moving only in a perfectly straight line)

FIG. 14 to FIG. 22—mini straddle carrier in accordance with another possible embodiment

Turning now to FIG. 14 to FIG. 22, as mentioned above, these Figures illustrate yet another possible embodiment of the invention. In this embodiment, the straddle carrier is a mini straddle carrier.

Importantly, a number of components and systems that would normally be required by or part of a straddle carrier (e.g. hydraulic systems, hydraulic lines, etc, to name a few) are omitted in FIG. 14 to FIG. 22. However, the purpose and operation of these components and systems will be evident to those skilled in this area, and in any case a number of these are described above (at least by way of example) with reference to FIG. 2. Hence, there is no need for these components and systems to be illustrated or described any further. Having said this, any of these components and systems (including but not limited to those described above with reference to FIG. 2) may of course be used or incorporated in straddle carriers like the one in FIG. 14 to FIG. 22 or which otherwise embody the invention.

Also, the configuration of the mini straddle carrier in FIG. 14 to FIG. 22 (e.g. the frame design and structural configuration, the wheel/bogie design, its dimensions and overall layout, etc) is intended as an illustrative schematic representation only. That is, FIG. 14 to FIG. 22 are intended merely to help illustrate certain important features and functionalities which the invention may provide, and certain potential benefits it may have, when embodied in the form of a mini straddle carrier. However, it is to be clearly understood that, in practice, the actual configuration/structure/construction of a straddle carrier embodying the invention could be quite different to that shown in FIG. 14 to FIG. 22. Even if so, any straddle carrier with a differing configuration/structure but with one or more features and/or functionalities that are shared with or common/equivalent to the present invention will still fall within the scope of the present invention.

The overall layout of the mini straddle carrier in FIG. 14 to FIG. 22 is similar, at least in general terms, to the layout of the mini straddle carrier in FIG. 2. For instance, like the mini straddle carrier in FIG. 2, the mini straddle carrier in FIG. 14 to FIG. 22 includes four main upright support members (hereafter “legs”) 200a-200d.

However, unlike the uprights *10a-*10d of the straddle carrier in FIG. 2 which are rigid and of fixed height, the uprights 200a-200d of the straddle carrier in FIG. 14 to FIG. 22 are height adjustable. In the particular mini straddle carrier embodiment in FIG. 14 to FIG. 22, each of the uprights 200a-200d is height adjustable in a generally telescopic manner. In fact, it will be seen that legs 200a-200d each have a three part construction, and the respective parts of each leg are able to move vertically and somewhat telescopically relative to one another. The three parts of leg 200a are the main pillar 203a, the middle slider 204a and the upper slider 205a. Similarly, leg 200b has a main pillar 203b, a middle slider 204b and an upper slider 205b, and it is the same for the other legs as well.

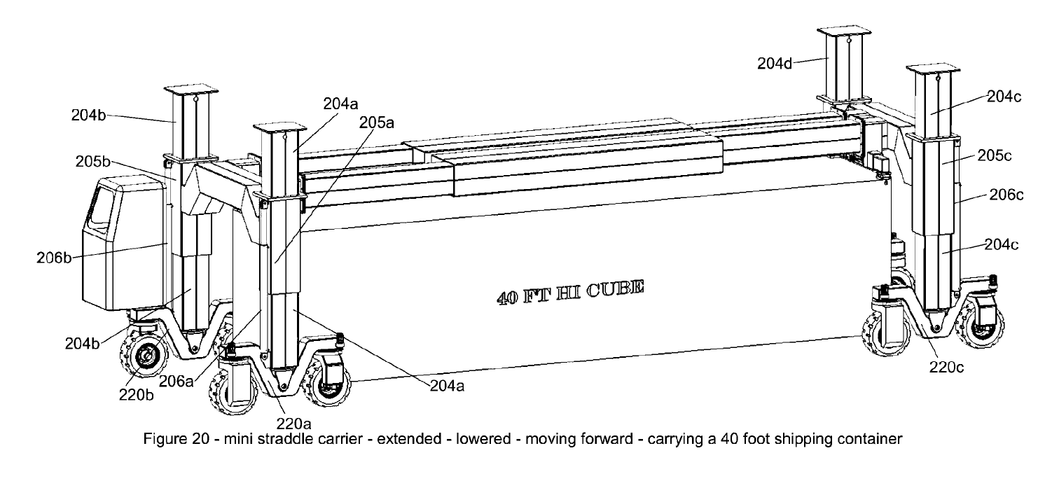

The way in which this three part construction of the legs allows the mini straddle carrier in this embodiment to be height adjustable can be understood by comparing any of FIG. 14 to FIG. 19 or FIG. 21 to FIG. 22 with FIG. 20. FIG. 14 to FIG. 19 and FIG. 21 to FIG. 22 all show the mini straddle carrier in a fully raised configuration where the straddle carrier's legs are extended to their maximum height. In contrast, FIG. 20 illustrates the straddle carrier in a fully lowered configuration where the legs have been telescopically lowered/retracted such that the overall height of the straddle carrier is reduced.

It should be noted that, on the respective legs 200a-d, the middle sliders 204a-d are mounted so as to be telescopically slidable relative to, and on the outside of, the respective main pillars 203a-d. Also, on the respective legs 200a-d, the upper sliders 205a-d are mounted so as to be telescopically slidable relative to, and on the outside of, the respective middle sliders 204a-d. Therefore, when the mini straddle carrier's legs 200a-d are telescopically lowered/retracted to convert the straddle carrier from the raised configuration (FIG. 14 to FIG. 19 and FIG. 21 to FIG. 22) into the lowered configuration (FIG. 20), the middle sliders 204a-d on the respective legs slide telescopically down the outside of the main pillars 203a-d, and the upper sliders 205a-d on the respective legs slide telescopically down the outside of the middle sliders 204a-d.

Note that the middle sliders 204a-d may be able to move (up or down) relative to the main pillars 203a-d, even if there is no associated movement of the upper sliders 205a-d relative to the middle sliders 204a-d. Likewise, it may be possible for the upper sliders 205a-d to move (up or down) relative to the middle sliders 204a-d, even if there is no associated movement of the middle sliders 204a-d relative to the main pillars 203a-d. Of course, it is also possible for all of the different parts of the respective legs to move relative to one another at the same time. These different possibilities for relative movement the different parts of the legs may allow the height of the straddle carrier to be adjusted to any desired height in between the fully raised and fully lowered configurations.

It will be seen that there is an external hydraulic cylinder on the outside of each of the legs. That is, there is an external hydraulic cylinder 206a on leg 200a, an external hydraulic cylinder 206b on leg 200b, etc. The lower ends of the hydraulic cylinders 206a-d attach at the bottom of the respective middle sliders 204a-d, and the upper ends of the hydraulic cylinders 206a-d attach at the top of the respective upper sliders 205a-d. Hence, hydraulically-driven extension of the hydraulic cylinders 206a-d causes the respective upper sliders 205a-d to slide telescopically upwards relative to the middle sliders 204a-d, and conversely retraction of the hydraulic cylinders 206a-d causes the respective upper sliders 205a-d to slide telescopically downwards relative to the middle sliders 204a-d. This is therefore how movement of the upper sliders 205a-d relative to the middle sliders 204a-d is achieved in this embodiment.

There are also mechanisms (typically, although not necessarily, hydraulically driven mechanisms) which operates to lift and lower the middle sliders 204a-d relative to the respective associated main pillars 203a-d. These mechanisms are not illustrated in FIG. 14 to FIG. 22. It will be appreciated that these mechanisms may be mounted internally inside the respective legs (and hence out of sight in FIG. 14 to FIG. 22). The engine, pumps, etc, used by these (and other) hydraulic systems may be housed within the mini straddle carrier's engine cover 224 and make be controlled using controls accessible from the driver cabin 222.

The state of extension/retraction of the mini straddle carrier's legs will usually be the same for all of the legs at a given time. In other words, at any given time, the state of extension of one of the legs, and the relative position of the middle slider relative to the main pillar and of the upper slider relative to the middle slider, will be the same for all legs. However, it is also possible that small differences or small progressively controllable variations in the position of certain parts of only certain leg(s) (i.e. not all legs at once) may be used when a container is being lifted, or when the straddle carrier is moving carrying the container, to slightly tilt or level the container, etc.

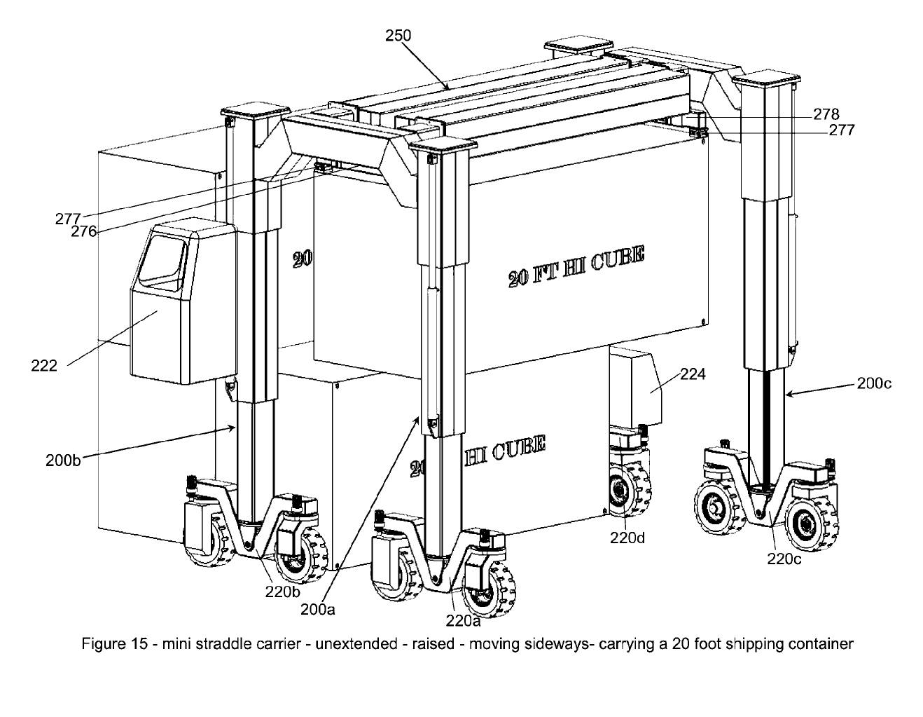

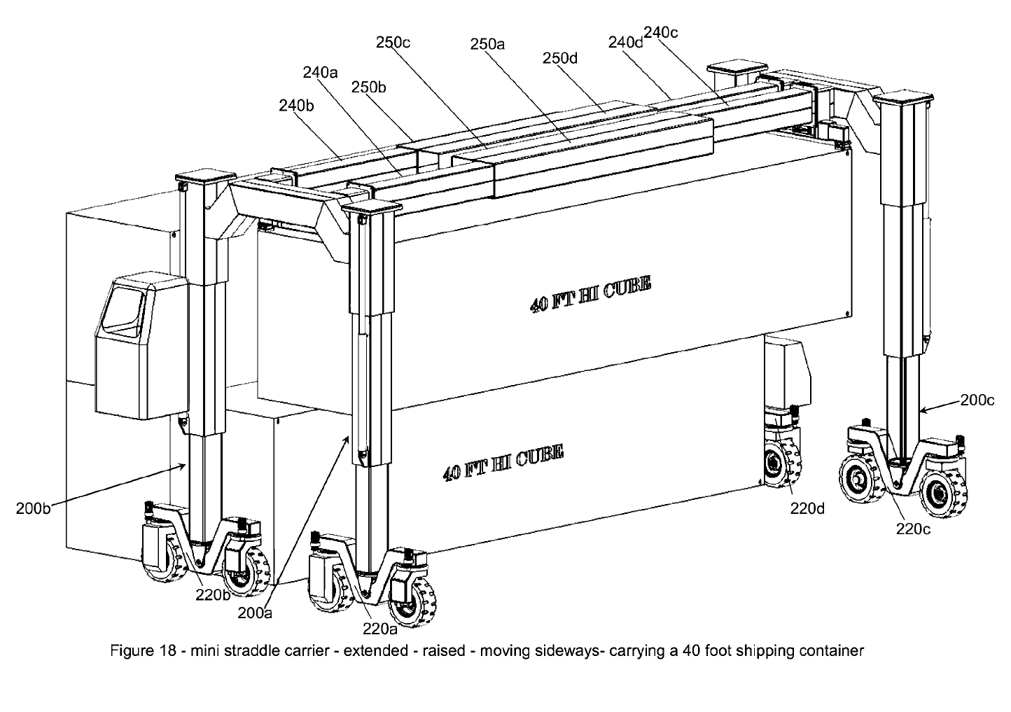

It should also be appreciated that the ability of the legs 200a-d to extend and retract is used not only to adjust the height of the mini straddle carrier (and the height at which the straddle carrier carries the shipping container), but this is also the means by which the straddle carrier actually lifts a container off the ground. In other words, when the mini straddle carrier is to pick up a container, the straddle carrier must initially be positioned over the container, and the straddle carrier must then be lowered (using the legs) such that the straddle carrier's attachment points 277 can attach to the respective top corners of the container. Then, once the top corners of the container are attached to the straddle carrier's attachment points 277, the straddle carrier's legs can be extended to lift the container off the ground. Sometimes, the straddle carrier may lift the container only a small distance off the ground (sufficient for the container to be safely driven/transported without dragging or colliding with the ground). In other circumstances, such as for example where the container is to be placed on top of another container (as illustrated in FIG. 15 and FIG. 18) or on a vehicle, the straddle carrier may need to extend to its fully raised configuration (or close to it) in order to lift the container to a sufficient height to do so.

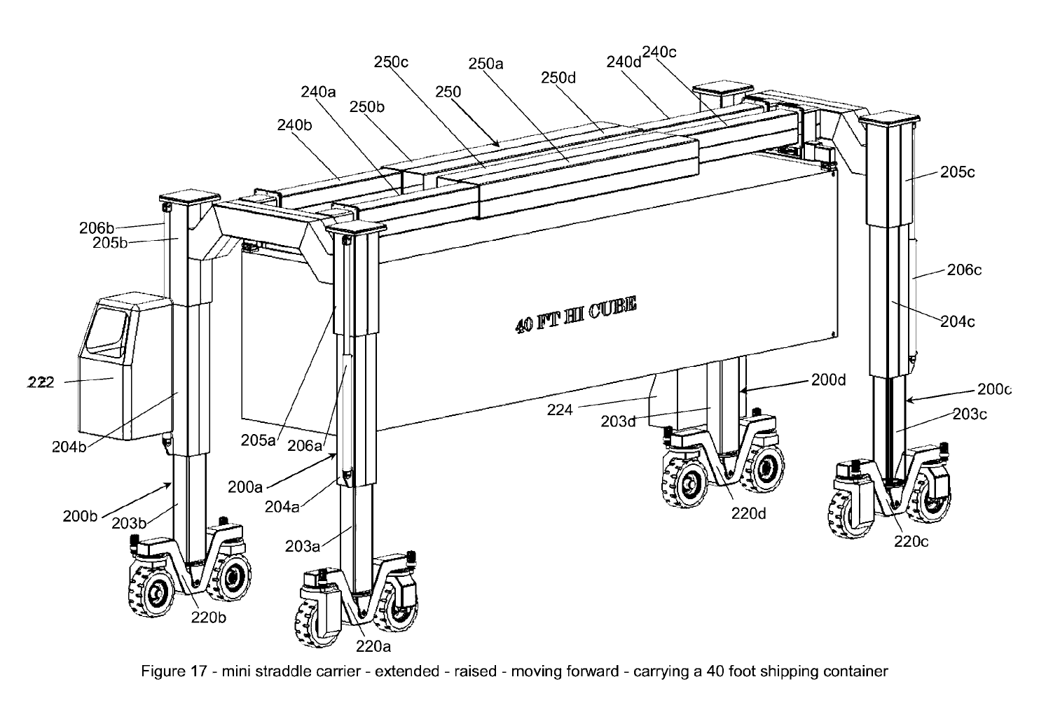

In addition to being height-adjustable, the mini straddle carrier in the embodiment in FIG. 14 to FIG. 22 is also a length-adjustable. In other words, the straddle carrier can be extended (lengthened) to increase the spacing between the front legs 200a/b and the rear legs 200c-d, and it can be retracted (shortened) to decrease the spacing between the front legs 200a/b and the rear legs 200c-d. FIG. 14 to FIG. 16 illustrate the mini straddle carrier in an unextended (shortened) configuration, whereas FIG. 17 to FIG. 21 illustrate the mini straddle carrier in an extended (lengthened) configuration.

In the specific mini straddle carrier embodiment in FIG. 14 to FIG. 22, the means by which the straddle carrier is length-adjustable (i.e. structural configuration by which this is made possible), is somewhat similar to the way this is achieved in the large straddle carrier embodiments of FIG. 3 to FIG. 10 and FIG. 11 to FIG. 13 discussed above. For instance, the mini straddle carrier in FIG. 14 to FIG. 22 has a central guide structure 250. The guide structure 250 is located between the front and rear legs of the straddle carrier and it receives and supports the mini straddle carrier's longitudinal beams 240a-d. More specifically, and like in the large straddle carrier embodiments above, on either side the guide structure 250 includes a pair of hollow rectangular through-channels. On either side, one of the through-channels is disposed horizontally alongside the other. These through-channels are sized and shaped such that each one receives one of the mini straddle carrier's respective longitudinal beams 240a-d, and the longitudinal beams are each able slide within their respective through-channel when the distance between the front and rear legs of the mini straddle carrier is changed. The individual through-channels of the guide structure 250 are labelled 250a-250d. It will be appreciated that the longitudinal beam 240a is slideably received within through-channel 250a, the longitudinal beam 240b is slideably received within through-channel channel 250b, etc.

The configuration of the guide structure 250 therefore enables the longitudinal beams 240a/b associated with the front legs 200a/b, and the longitudinal beams 240c/d associated with the rear legs 200c/d, respectively, to slide relative to the guide structure 250 (and relative to one another) when the distance between the front and rear legs is changed. However, aside from allowing this relative sliding movement of the longitudinal beams, the guide structure 150 otherwise forms a structural connection which holds the longitudinal beams together, keeps them suspended above (and generally parallel to) the ground, and it consequently helps to hold the mini straddle carrier's overall frame structure together.

At this point, it is important to note one particular configurational difference between the mini straddle carrier in FIG. 14 to FIG. 22 and the large straddle carriers in FIG. 3 to FIG. 13 above. In the large straddle carrier embodiments in FIG. 3 to FIG. 13 above, the large straddle carrier incorporated a spreader for attaching to a shipping container, and the spreader was movably mounted to the main structure of the large straddle carrier by an intermediate frame. In contrast to this, the mini straddle carrier in FIG. 14 to FIG. 22 has neither a spreader nor an intermediate frame. On the contrary, in FIG. 14 to FIG. 22, the attachment points 277 which can connect to respective top corners of a shipping container are all rigidly attached to the mini straddle carrier's main structure. More specifically, in the mini straddle carrier in FIG. 14 to FIG. 22, the attachment points 277, and the rigid cross members 276 and 278 on which the attachment points 277 are located, are rigidly mounted on towards (and beneath) outermost ends of the respective longitudinal beams 240a-d.

Consequently, when the mini straddle carrier in FIG. 14 to FIG. 22 is to pick up a container, not only must the straddle carrier be initially be positioned over the container, but the straddle carrier's front and rear legs must then be moved relative to one another (i.e. the spacing between the front and rear legs must be adjusted) so as to correctly positioned the attachment points 227 above the corresponding top corners of the container to which they are to connect. Only then can the straddle carrier be lowered (using the legs) such for attachment points 277 to actually attach to the respective top corners of the container. Of course, once the attachment points 277 are connected to the respective top corners of the container, the container can then be picked up and transported, as explained above.

In the mini straddle carrier in FIG. 14 to FIG. 22, the actual way in which the spacing between the front legs 200a/b and rear legs 200c/d is varied (i.e. the way in which the overall straddle carrier is extended and retracted) is not critical and any suitable means for achieving this may be employed.

For example, a hydraulically actuated mechanical mechanism might be used which is similar to that described in connection with the large straddle carrier in FIG. 3 to FIG. 10 above. Such a hydraulic mechanism might involve, say, four hydraulic cylinders (not illustrated). One of these hydraulic cylinders might have one of its ends connected to the longitudinal beam 240a and its other end connected to the guide structure 150 on the outside of the through-channel 250a (this being the through-channel in the guide structure in which the longitudinal beam 240a is received). Similarly, another of the hydraulic cylinders might have one of its ends connected to the longitudinal beam 240b and its other end connected to the guide structure 250 on the outside of the through-channel 250b, etc. Hence, operating these hydraulic cylinders to lengthen/extend would force the respective longitudinal beams 240a-d to slide within their respective through channels 250a-d such that the spacing between the front legs and the rear legs increases. Alternatively, operating the hydraulic cylinders to shorten/retract would cause the respective longitudinal beams 240a-d to slide within their respective through channels 250a-d such that the spacing between the front legs and the rear legs reduces. Those skilled in the art will appreciate that, in order for hydraulic cylinders such as those just described to operate to extend/retract the straddle carrier, when the hydraulic cylinders are being operated to extend/retract, the wheels on the base of each of the straddle carrier's legs should be oriented to roll in a direction parallel to the straddle carrier's forward axis, and they should be “free” to roll (not locked or braked). This is so that the extension/retraction of the straddle carrier, by the hydraulic cylinders, is not prevented/inhibited by any of the wheels being locked against rotation, or by any of the wheels being oriented in the wrong orientation (i.e. pointing in the wrong direction).

Another possibility for extending and retracting the mini straddle carrier in FIG. 14 to FIG. 22 might involve driving the straddle carrier's own wheels. As will be discussed further below, at least one wheel in each of the straddle carrier's bogies 220a-d will be a “driven” wheel. (Typically, each “driven” wheel will have an internal hydraulic motor to drive rotation of that wheel.) Therefore, because at least one of the wheels in each of the straddle carrier's bogies is driven, another way in which the spacing between the front and rear legs might be altered is to, for example, lock one or more wheels on each of the rear bogies against rotation (thus securing the rear bogies and the rear legs in position) and to then drive the wheels on the front bogies 220a and 220b such that the front bogies and the front legs move relative to (i.e. away from, or towards) the rear bogies and the rear legs. Obviously, driving the front bogies 220a and 220b away from the rear bogies would cause the spacing between the straddle carrier's front and rear legs to increase, whereas driving the front bogies 220a and 220b towards the rear bogies would cause the spacing between the front and rear legs to decrease. Also, it would be equally possible to lock one or more of the wheels on each of the front bogies and two drive the rear bogies (and hence the rear legs) relative to the front bogies (and the front legs). Furthermore, it may even be possible to drive both of the front bogies, and both of the rear bogies, at the same time.

The above method of altering the spacing between the mini straddle carrier's legs, namely by using the “driven” wheels to move the front and/or rear bogies relative to one another, might even be used in combination with the system of hydraulic cylinders discussed above. Therefore, for example, the straddle carrier might have a system of hydraulic cylinders as discussed above, and when the hydraulic cylinders are operated to extend/retract thereby slidingly extending/retracting the longitudinal beams 240a-d relative to the guide structure 250, at the same time the driven wheels on the front and/or rear bogies may also be driven in the appropriate direction. This may help to prevent undesirable stresses, bending, flexure, etc, in the straddle carrier by ensuring that the spacing between the tops of the straddle carrier's front and rear legs remains the same, and changes at the same rate, as the spacing between the bottoms of the straddle carrier's front and rear legs.

A number of possibilities are discussed above for the way in which the spacing between the mini straddle carrier's front legs 200a/b and rear legs 200c/d might be varied. However, these are discussed mere as possible examples, and the invention is not limited in any way to or by these. Therefore, any other suitable mechanism for extending/retracting the straddle carrier may be used.

In the mini straddle carrier in FIG. 14 to FIG. 22 there is a wheeled bogie 220 attached to the base of each of the straddle carrier's legs. The bogie attached to the base of the straddle carrier's front left leg 200a is bogie 220a, the bogie attached to the base of the front right leg 200b is the bogie 220b, etc. Each of the bogies 220a-d has two wheels. (In other embodiments, each of the bogies, or some of them, might be provided with a greater number of wheels.) The reason why it is important for each of the bogies have two (or more) wheels is generally similar to the reason explained above with reference to the straddle carrier in FIG. 2. That is (just like for the mini straddle carrier in FIG. 2) the wheels of the mini straddle carrier in FIG. 14 to FIG. 22, and even wheels which are connected to the same bogie, are separated from each other by an appreciable distance. The reason for the separation (i.e. distance) between individual wheels is to distribute the straddle carrier's load over a greater number of separated (i.e. spaced apart) contact points, such that each individual contact point bears less of the overall load, thus reducing the propensity for damage to the concrete surface on which the straddle carrier operates.

In the embodiment in FIG. 14 to FIG. 22, the wheels on the respective bogies support the bogies on the ground, and the bogies together in turn support the full weight of the rest of the straddle carrier (and its load). Each of the wheels includes a rubber tyre (typically, although not necessarily exclusively, a pneumatic tyre) for providing grip/traction.

One way in which the bogies 220a-d of the mini straddle carrier in FIG. 14 to FIG. 22 differ from the bogies in the large straddle carrier embodiments discussed above is that, in FIG. 14 to FIG. 22, each of the bogies is able to tilt or rock or “seesaw” in a vertical plane relative to its leg. This aspect of the bogie design in FIG. 14 to FIG. 22 is therefore similar to the design of the bogies in FIG. 2 which are also able to “seesaw”. The reason for this is also the same as described with reference to FIG. 2, namely so that both wheels (in this embodiment) of a bogie can remain in contact with the ground even that bogie is moving overground that is slightly sloping or uneven.

It has been mentioned previously that, typically, at least one wheel on each of the bogies 220a-d will be a driven wheel. Each driven wheel may be provided with an internal hydraulic motor to drive rotation of that wheel (although other means for imparting rotation into the “driven” wheels may also be used). It is possible that, for all or some of the bogies, both of the wheels of the bogie might be driven, or in embodiments where bogies includes a greater number of wheels, some or all of the wheels of each bogie may be driven. In any case, whilst this is possible, it is envisaged that normally only one of the wheels on each bogie will be a driven wheel.

Whilst it may often be the case that only one of the wheels on each bogie is a driven wheel, it is important for all wheels on all of the bogies to be turnable/steerable (regardless of the number of wheels per bogie). Obviously, the various wheels will not all always turn/steer by the same amount at the same time. Indeed, it will often be necessary for some wheels to turn by a different amount compared to others in order for the straddle carrier to steer or track correctly. Nevertheless, it is important for all of the wheels of all of the bogies to be able to be turned/steered. One particular reason why this is important will be more easily understood from the discussion below of the way in which the bogies can pivot relative to the respective legs of the straddle carrier, and the consequences of this. The actual way in which each of the straddle carrier's wheels is turned/steered is not critical to the invention. Therefore, any means for turning/steering each of the straddle carrier's wheels may be used.

On each bogie, the various wheels might also be turnable/steerable independently of the other wheel(s) on that bogie. Alternatively, mechanisms or systems might be provided which operate such that, on each bogie, the turning/steering of one wheel on that bogie is related/linked to the amount by which other wheel(s) on that bogie turn/steer.

One of the important functionalities of the mini straddle carrier in FIG. 14 to FIG. 22 (and this is similar to the embodiments of the large straddle carriers discussed above) is that each of the bogies 220a-d is able to pivot by at least 90° in the horizontal plane relative to the leg to which it is attached. In other words, each of the bogies 220a-d is able to pivot horizontally relative to its respective leg 200a-d by at least 90°. Hence, bogie 220a is able to pivot horizontally by at least 90° relative to leg 200a, bogie 220b is able to pivot horizontally by at least 90° relative to leg 200b, etc.

This ability of the bogies to pivot relative to their respective legs is depicted in FIG. 16 and FIG. 19. Also, in FIG. 14 and FIG. 17, the bogies 220a-d are oriented parallel to the straddle carrier's forward axis. That is to say, bogies 220a and 220c are aligned such that their respective wheels form a single line parallel to the straddle carrier's forward axis. The same is true of bogies 220b and 220d, the wheels of which also form a single line parallel to the straddle carrier's forward axis. In contrast, in FIG. 15 and FIG. 18, the bogies 220a-d are oriented perpendicular to the straddle carrier's forward axis. That is to say, bogies 220b and 220a are aligned such that their respective wheels form a single line perpendicular to the straddle carrier's forward axis. The same is true of bogies 220d and 220c, the wheels of which also form a single line perpendicular to the straddle carrier's forward axis. When the bogies 220 are arranged relative to one another in this way (i.e. as shown in FIG. 15 and FIG. 18) these are configurations which the straddle carrier can adopt, for example, if it is required to place a shipping container on top of another shipping container, or to lift a shipping container off the top of another container (or off a stack of other containers), in circumstances where it is not possible for the straddle carrier to drive lengthwise over the top of the said other shipping container(s) due to the presence of yet other nearby containers or other obstacles. These configurations (i.e. as shown in FIG. 15 and FIG. 18) might also be used in circumstances where (even absent other obstacles) there is not enough space/room in a given area for the straddle carrier to drive into the area forwards/lengthwise (or there is not enough room for the container to be placed lengthwise), but it is nevertheless possible to drive the straddle carrier into the said area sideways (or the space would permit a container to be placed therein sideways). The importance of this was discussed above in connection with the large straddle carrier embodiments, and with reference to FIG. 23. These reasons apply equally to the mini straddle carrier in FIG. 14 to FIG. 22 but need not be repeated.

One possible way that the respective bogies of the straddle carrier in FIG. 14 to FIG. 22 might be caused to pivot relative to their respective legs would be for the wheels on each bogie to first pivot relative to the bogie (i.e. to steer) so as to become oriented substantially perpendicular to the bogie itself, as shown in FIG. 16 and FIG. 19. When all wheels are in this orientation relative to their respective bogies, if a wheel rolls, it will roll in a direction perpendicular to the lengthwise axis of its bogie. Therefore, after all of the wheels have been turned relative to their respective bogies in this manner, the driven wheel(s) on each bogie could then be “driven” (i.e. caused to rotate/roll) in the appropriate direction such that the respective bogies are thereby caused to pivot (i.e. rotate in the horizontal plane about a vertical axis) relative to their respective vertical legs. The legs themselves will typically remain stationary. Therefore, apart from the pivoting movement of the respective bogies, the straddle carrier would typically otherwise remain motionless during this process.

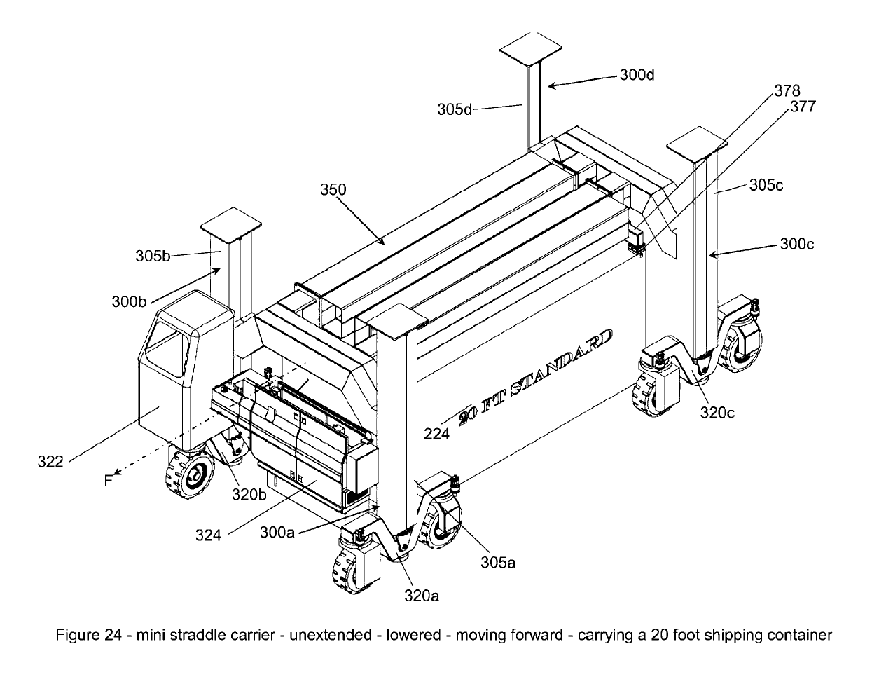

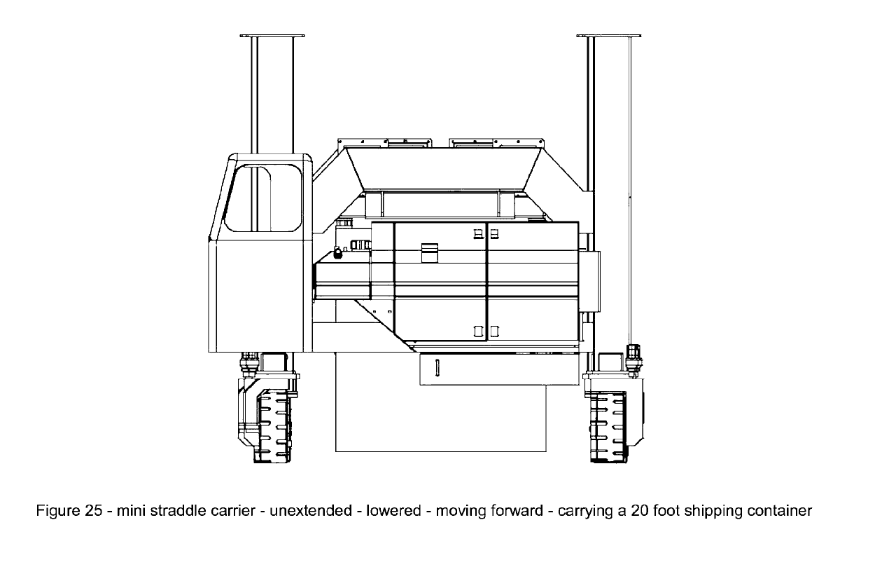

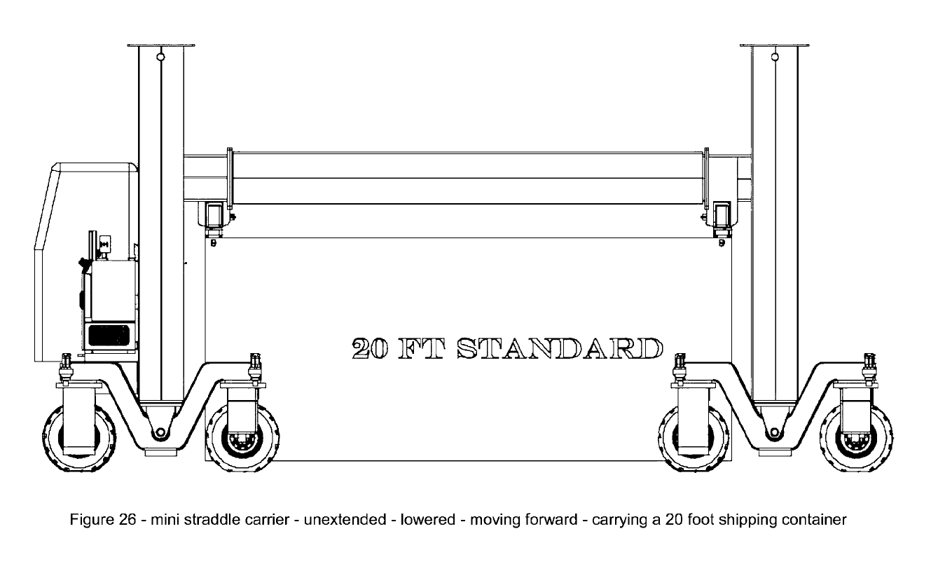

FIG. 24 to FIG. 26—mini straddle carrier in accordance with another possible embodiment

Turning now to FIG. 24 to FIG. 26, as mentioned above, these Figures illustrate yet another possible embodiment of the invention. In this embodiment, like the embodiment in FIG. 14 to FIG. 22, the straddle carrier is a mini straddle carrier. Actually, the mini straddle carrier in FIG. 24 to FIG. 26 is similar in many ways to the mini straddle carrier in FIG. 14 to FIG. 22. Accordingly, the mini straddle carrier in FIG. 24 to FIG. 26 will not be described in as much detail as the mini straddle carrier in FIG. 14 to FIG. 22. In fact, the mini straddle carrier in FIG. 24 to FIG. 26 will be discussed mainly only insofar as is necessary to identify ways in which it differs from the mini straddle carrier in FIG. 14 to FIG. 22.

One immediately noticeable difference between the mini straddle carrier in FIG. 24 to FIG. 26 and the mini straddle carrier in FIG. 14 to FIG. 22 relates to the mounting location of the engine, pumps, etc. In the mini straddle carrier in FIG. 14 to FIG. 22, these things are mounted inside the engine cover 224, which is in turn mounted on the outside of the straddle carrier's rear right leg 200d. In contrast, in the mini straddle carrier in FIG. 24 to FIG. 26, the engine cover 324 (inside which the engine, pump(s), fuel tank, electrics, etc, are housed) is mounted adjacent the driver's cab 322, such that the engine cover 324 effectively extends between the front legs 300a and 300b.

This alternative mounting location for the engine, pump(s), etc, is significant for a number of reasons. One possible downside of this alternative mounting location is that it means the straddle carrier is unable to drive all the way over the top of a shipping container in a direction parallel to the straddle carrier's forward axis. Therefore the straddle carrier is also unable to lift a shipping container and then (whilst carrying the container) drive forwards over another shipping container. As a result, with the mini straddle carrier in FIG. 24 to FIG. 26, it is not possible while carrying a container to drive forwards over the top of another container that is resting on the ground. Having said this, it is still perfectly possible to drive sideways over the top of a container, or while carrying a container to drive sideways over the top of another container. Also, with the mini straddle carrier in FIG. 24 to FIG. 26, if it is necessary to place a container on top of another lower container which is resting on the ground in a circumstance where the straddle carrier must move over the said lower container in a direction parallel to the straddle carrier's forward axis (e.g. due to nearby obstacles), it is necessary for the straddle carrier to do so by reversing over the lower container before placing the lifted container on top of the lower container.

There are, however, also a number of advantages associated with the alternative mounting location for the engine, pump(s), etc, in the mini straddle carrier in FIG. 24 to FIG. 26. For example, by mounting the engine, pump(s), etc, in this location, any additional structural mounting members (not illustrated) located between the straddle carrier's front legs and to which these things are mounted may help to reinforce or increase the structural rigidity of the straddle carrier (and its frame). Also, because the engine, pump(s), etc, are located much closer to the driver's cabin (as compared with the embodiment in FIG. 14 to FIG. 22), there is much less need for long cabling, piping, etc, to connect the engine, pumps, actuators, etc, to the various controls in the driver's cabin that control them. This improves simplicity (by reducing difficult routing issues), and may also help to reduce the possibility of failure (e.g. because the less piping that is needed, the less piping that could potentially fail). It should also be noted that the location of the driver's cab in the mini straddle carrier embodiments discussed herein may be preferable over the location of the driver's cab in the large straddle carrier embodiments discussed herein at least insofar as, in the mini straddle carrier embodiments, the driver's cab can be brought closer to the ground, which is safer for the driver when getting into, and getting out of, the driver's cab. In the large straddle carrier embodiments, the driver's cab is always located a considerable distance above the ground, meaning the driver may often need ascend/descend a ladder to get into or out of the cab, which has a number of associated dangers.

Referring generally now to the mini straddle carrier in FIG. 24 to FIG. 26, the overall layout of this mini straddle carrier is similar, at least in general terms, to the layout of the mini straddle carriers in FIG. 2 and FIG. 14 to FIG. 22. For instance, like the mini straddle carrier in FIG. 2 and FIG. 14 to FIG. 22, the mini straddle carrier in FIG. 24 to FIG. 26 includes four main upright support members (hereafter “legs”) 300a-300d.

However, unlike the uprights *10a-*10d of the straddle carrier in FIG. 2 which are rigid and of fixed height (but like the uprights of the straddle carrier in FIG. 14 to FIG. 22), the uprights 300a-300d of the straddle carrier in FIG. 24 to FIG. 26 are height adjustable. In the particular mini straddle carrier embodiment in FIG. 24 to FIG. 26, each of the uprights 300a-300d is height adjustable in a generally telescopic manner. In fact, it will be understood that legs 300a-300d (although this is not actually visible in FIG. 24 to FIG. 26) each have a two part construction. The two parts of leg 300a are the main internal pillar (not visible) and an upper slider 305a. The main internal pillar of leg 300a (not visible) attaches at its lower end to the bogie 320a and extends vertically upward inside the upper slider 305a. The upper slider 305a can therefore move telescopically up and down on the main internal pillar. The other three legs also have a similar two part, telescopically extendable construction, and the way in which this allows the straddle carrier in FIG. 24 to FIG. 26 to be height adjustable will be readily apparent. Note that the hydraulic cylinders (or other mechanism) used for raising and lowering the mini straddle carrier are not illustrated in FIG. 24 to FIG. 26.

The state of extension/retraction of the mini straddle carrier's legs will usually be the same for all of the legs at a given time. In other words, at any given time, the state of extension of one of the legs, and the relative position of the upper slider relative to the main pillar, will be the same for all legs. However, it is also possible that small differences or small progressively controllable variations in the position of certain parts of only certain leg(s) (i.e. not all legs at once) may be used when a container is being lifted, or when the straddle carrier is moving carrying the container, to slightly tilt or level the container, etc.

It should also be appreciated that the ability of the legs 300a-d to extend and retract is used not only to adjust the height of the mini straddle carrier (and the height at which the straddle carrier carries the shipping container), but this is also the means by which the straddle carrier actually lifts a container off the ground. In other words, when the mini straddle carrier is to pick up a container, the straddle carrier must initially be positioned over the container, and the straddle carrier must then be lowered (using the legs) such that the straddle carrier's attachment points 377 can attach to the respective top corners of the container. Then, once the top corners of the container are attached to the straddle carrier's attachment points 377, the straddle carrier's legs can be extended to lift the container off the ground. Sometimes, the straddle carrier may lift the container only a small distance off the ground (sufficient for the container to be safely driven/transported without dragging or colliding with the ground). In other circumstances, such as for example where the container is to be placed on top of another container or on a vehicle, the straddle carrier may need to extend to its fully raised configuration (or close to it) in order to lift the container to a sufficient height to do so.

In addition to being height-adjustable, the mini straddle carrier in the embodiment in FIG. 24 to FIG. 26 is also a length-adjustable. In other words, the straddle carrier can be extended (lengthened) to increase the spacing between the front legs 300a/b and the rear legs 300c/d, and it can be retracted (shortened) to decrease the spacing between the front legs 300a/b and the rear legs 300c-d. The means by which this is achieved is substantially identical to the way it is achieved in the embodiments described with reference to FIG. 14 to FIG. 22, and this therefore need not be explained again. Also, in the embodiment in FIG. 24 to FIG. 26, the configuration of the bogies, their attachment and pivotability relative to the legs, the operation of the wheels, etc, is the same as in the embodiment in FIG. 14 to FIG. 22, so this too need not be explained again.

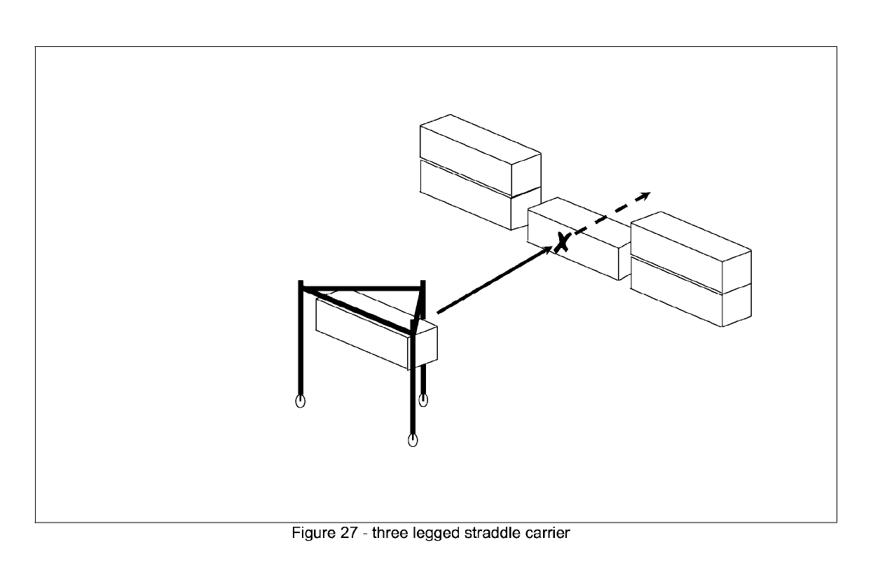

The straddle carriers in the various specific embodiments discussed so far with reference to the Figures have all had four legs. As has been mentioned, it is possible that an odd number of legs (e.g. three) may be provided in some embodiments. However, it is thought that providing an odd number of legs may sometimes restrict the versatility of the straddle carrier. One example of this restricted versatility is illustrated in FIG. 27 which schematically depicts a straddle carrier with three legs (the straddle carrier's three legs are arranged in a generally triangular configuration). In FIG. 27, there are two separate stacks of containers depicted, each stack comprising two containers (one atop the other), and in between these two stacks there is a single container resting on the ground. The four legged straddle carriers in the specific embodiments discussed above could easily navigate between the two side stacks to place a second container on top of the single centre container in FIG. 27. However, the three legged straddle carrier depicted in FIG. 27 could not do so. This is because, if the three legged straddle carrier were to approach the single centre container from the side, the triangular configuration of straddle carrier's legs would prevent it from being positionable over the top of the centre container (any attempt to position the straddle carrier directly over the top of the centre container would cause one of the straddle carrier's legs to collide with a container). Also, the three legged straddle carrier could not approach the centre container end on from either end, because the stacks of containers on either side are too high and would prevent it from doing so.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or an embodiment' means that a particular feature, structure, or characteristic described in connection with the embodiment is included in at least one embodiment of the present invention. Thus, the appearance of the phrases in one embodiment' or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A straddle carrier which is operable to lift, convey and set down a shipping container, the straddle carrier having a first direction being a direction which is parallel to a longitudinal axis of the container when the container is supported by the straddle carrier and a second direction being a direction which is perpendicular to the longitudinal axis of the container when the container is supported by the straddle carrier, the straddle carrier also having:
a plurality of weight-bearing portions which bear the weight of the shipping container when the container is supported above the ground by the straddle carrier; and
a plurality of wheeled structures between the weight-bearing portions and the ground, one wheeled structure supporting each weight-bearing portion above the ground, wherein
each wheeled structure has two or more wheels, the wheels on each wheeled structure being connected to the wheeled structure at locations that are spaced apart from each other, at least, relative to a lengthwise axis of the wheeled structure;
each of the wheels is turnable relative to the wheeled structure to which it is connected; and
each wheeled structure is pivotable relative to the weight-bearing portion which it supports;
wherein
the wheeled structures can be oriented with their lengthwise axes parallel to the straddle carrier's first direction and with their wheels oriented so as to enable the straddle carrier to move in or parallel to the straddle carrier's first direction, including whilst conveying a shipping container, albeit also with the ability to steer by turning one or more wheels; and
the wheeled structures can also be oriented with their lengthwise axes parallel to the straddle carrier's second direction and with the wheels oriented so as to enable the straddle carrier to move in or parallel to the straddle carrier's second direction, including whilst conveying a shipping container, albeit also with the ability to steer by turning one or more wheels,
and the straddle carrier can
set down a container and then move away from the set down container, or approach or move over an already set down container, in or parallel to the first direction, and
set down a container and then move away from the set down container, or approach or move over an already set down container, in or parallel to the second direction.

2. The straddle carrier as claimed in claim 1, wherein the horizontal spacing between at least certain of the straddle carrier's weight-bearing portions can be varied.

3. The straddle carrier as claimed in claim 2, wherein the horizontal spacing between at least certain of the straddle carrier's weight-bearing portions parallel to the straddle carrier's first direction can be varied.

4. The straddle carrier as claimed in claim 3, wherein the straddle carrier has four weight-bearing portions, two at the front relative to the straddle carrier's first direction and two at the rear, and the horizontal spacing between the front weight-bearing portions and the rear weight-bearing portions can be varied.

5. The straddle carrier as claimed in claim 4, wherein the straddle carrier has
at least one front longitudinal member which is fixed in position relative to the front weight-bearing portions and which extends towards the rear weight-bearing portions,
at least one rear longitudinal member which is fixed in position relative to the rear weight-bearing portions and which extends towards the front weight-bearing portions, and
the horizontal spacing between the front weight-bearing portions and the rear weight-bearing portions can be varied by causing the horizontal position of the front longitudinal member(s) to be changed relative to the horizontal position of the rear longitudinal member(s) parallel to the straddle carrier's first direction.

6. The straddle carrier as claimed in claim 5, wherein the straddle carrier has a guide structure located between the front and rear weight-bearing portions, both the front longitudinal member(s) and the rear longitudinal member(s) engage with and are supported by the guide structure, and when the horizontal spacing between the front weight-bearing portions and the rear weight-bearing portions is varied one or both of the front longitudinal member(s) and the rear longitudinal member(s) move horizontally relative to the guide structure parallel to the straddle carrier's first direction.

7. The straddle carrier as claimed in claim 1, wherein the straddle carrier is operable to lift a shipping container to varying heights.

8. The straddle carrier as claimed in claim 1, wherein the straddle carrier is operable to lift a shipping container to a sufficient height, and to then position that container above at least one other already set down container, such that the container can be placed on top of the at least one other already set down container.

9. The straddle carrier as claimed in claim 7, wherein the straddle carrier can move whilst conveying a shipping container and also whilst not conveying a shipping container in or parallel to the second direction and over the top of an already set down container.

10. The straddle carrier as claimed in claim 1, wherein the straddle carrier can move so as to be positioned substantially over a shipping container, or over multiple shipping containers stacked one atop another, and can then lift the topmost shipping container.

11. A straddle carrier as claimed in claim 1, further comprising one or more attachment points where the shipping container can attach to the straddle carrier, and the straddle carrier can be operated to adjust the height of the one or more attachment points relative to the ground.

12. The straddle carrier as claimed in claim 11, wherein the straddle carrier has four weight-bearing portions and four attachment points, one attachment point being located near a vertically upper location on each of the respective weight-bearing portions, and the location of each attachment point relative to the vertically upper location on its associated weight-bearing portion is fixed.

13. The straddle carrier as claimed in claim 12, wherein the height of the respective weight-bearing portions can be varied, and varying the height of the respective weight bearing portions causes the height of the respective attachment points relative to the ground to vary.

14. The straddle carrier as claimed in claim 13, wherein each of the four weight-bearing portions comprises a substantially vertical leg, each leg includes a plurality of parts which can move vertically relative to one another to vary the height of the leg, and on each leg the attachment point associated with that leg is located near the top of the uppermost of the parts.

15. The straddle carrier as claimed in claim 1, further comprising a spreader assembly, the spreader assembly having one or more attachment points to which the shipping container can attach, and the height of the one or more attachment points relative to the ground can be varied by varying the height of the spreader assembly above the ground.

16. The straddle carrier as claimed in claim 6, further comprising a spreader assembly, the spreader assembly having one or more attachment points to which the shipping container can attach, the height of the one or more attachment points relative to the ground can be varied by varying the height of the spreader assembly above the ground, and the spreader assembly is connected to the rest of the straddle carrier via an intermediate frame.

17. The straddle carrier as claimed in claim 16, wherein the intermediate frame is suspended from the guide structure in a height-adjustable manner, and the spreader assembly is connected to the intermediate frame.

18. The straddle carrier as claimed in claim 17, wherein a lifting mechanism is provided, the height of the intermediate frame and the spreader assembly relative to the ground can be varied by operating the lifting mechanism.

19. The straddle carrier as claimed in claim 18, wherein the lifting mechanism comprises one or more winches, the winches being fixed in position relative to the guide structure and the intermediate frame being suspended by the winches such that the height of the intermediate frame and the spreader assembly relative to the ground can be varied by operating the winches.

20. The straddle carrier as claimed in claim 16, wherein the intermediate frame is length adjustable having a forward portion which is maintained in fixed horizontal position relative to the front weight-bearing portions and a rearward portion which is maintained in fixed horizontal position relative to the rear weight-bearing portions such that when the horizontal spacing between the front weight-bearing portions and the rear weight-bearing portions is varied the horizontal spacing between the forward and rearward portions of the intermediate frame changes accordingly.

21. The straddle carrier as claimed in claim 20, wherein the forward and rearward portions of the intermediate frame are able to move vertically relative to the respective front and rear weight-bearing portions when the height of the intermediate frame is varied.

22. The straddle carrier as claimed in claim 21, wherein the spreader assembly provides a plurality of attachment points, one or more toward the front and one or more towards the rear, and the spreader assembly is length-adjustable such that the horizontal spacing between the front and rear attachment points can be varied, and wherein the horizontal spacing between the front and rear attachment points on the spreader assembly, and the horizontal spacing between the front weight-bearing portions, can each be varied independently of one another.

23. The straddle carrier as claimed in claim 1, wherein at least one wheel of the straddle carrier is a driven wheel.

24. The straddle carrier as claimed in claim 1, wherein at least one wheel on each wheeled structure is a driven wheel.

25. The straddle carrier as claimed in claim 24, wherein each of the wheeled structures is able to pivot relative to the associated weight-bearing portion so that each wheeled structure can be controllably oriented with its lengthwise axis parallel to, or perpendicular to, the straddle carrier's first direction.

26. The straddle carrier as claimed in claim 24 wherein, in order to pivot each wheeled structure
the wheels on each wheeled structure are first turned relative to the wheeled structure so as to become oriented substantially perpendicular to the wheeled structure's lengthwise axis,
the driven wheel(s) on each wheeled structure are then “driven” in an appropriate direction such that the wheeled structures are thereby caused to pivot relative to their respective weight-bearing portions.

27. The straddle carrier as claimed in claim 1, wherein each of the wheeled structures is provided with a mechanism for lifting and pivoting that wheeled structure relative to the associated weight-bearing portion, whereby each wheeled structure can be lifted off the ground, pivoted, and lowered back to the ground, and in this way each wheeled structure is able to pivot relative to the associated weight-bearing portion so as to be selectably oriented with its lengthwise axis parallel to the straddle carrier's first direction or parallel to the straddle carrier's second direction.

28. A straddle carrier which is operable to lift, convey and set down a shipping container, the straddle carrier having a plurality of weight-bearing portions which bear the weight of the shipping container when the container is supported above the ground by the straddle carrier, the horizontal spacing between at least certain of the straddle carrier's weight-bearing portions can be varied, and the straddle carrier also has a first direction being a direction which is parallel to a longitudinal axis of the container when the container is supported by the straddle carrier and a second direction being a direction which is perpendicular to the longitudinal axis of the container when the container is supported by the straddle carrier, and the straddle carrier can
move in or parallel to the first direction and also in or parallel to the second direction, including in either case whilst conveying a shipping container, and also in either case with the ability to steer by turning one or more wheels,
set down a container and then move away from the set down container, or approach or move over an already set down container, in or parallel to the first direction, and
set down a container and then move away from the set down container, or approach or move over an already set down container, in or parallel to the second direction.

29. The straddle carrier as claimed in claim 28 wherein, the horizontal spacing between at least certain of the straddle carrier's weight-bearing portions can be varied parallel to the straddle carrier's first direction.

30. A straddle carrier which is operable to lift, convey and set down a shipping container, the straddle carrier having a first direction being a direction which is parallel to a longitudinal axis of the container when the container is supported by the straddle carrier and a second direction being a direction which is perpendicular to the longitudinal axis of the container when the container is supported by the straddle carrier, the straddle carrier also having:
a plurality of wheeled structures, wherein
each wheeled structure has two or more wheels, the wheels on each wheeled structure being connected to the wheeled structure at locations that are spaced apart from each other, at least, relative to a lengthwise axis of the wheeled structure;
each of the wheels is turnable relative to the wheeled structure to which it is connected; and
each wheeled structure is pivotable such that;
the wheeled structures can be oriented with their lengthwise axes parallel to the straddle carrier's first direction and with their wheels oriented so as to enable the straddle carrier to move in or parallel to the straddle carrier's first direction, including whilst conveying a shipping container, albeit also with the ability to steer by turning one or more wheels; and
the wheeled structures can also be oriented with their lengthwise axes parallel to the straddle carrier's second direction and with the wheels oriented so as to enable the straddle carrier to move in or parallel to the straddle carrier's second direction, including whilst conveying a shipping container, albeit also with the ability to steer by turning one or more wheels,
whereby the straddle carrier can
set down a container and then move away from the set down container, or approach or move over an already set down container, in or parallel to the first direction, and
set down a container and then move away from the set down container, or approach or move over an already set down container, in or parallel to the second direction.
